(19) United States
(12) Patent Application Publication
(10) Pub. No.: US 2010/0016392 A1
(43) Pub. Date: Jan. 21, 2010

(54) Pesticidal Aggregates

(75) Inventors: Alexander V. Kabanov, Omaha, NE (US); Michael Karas, Marlton, NJ (US); Tatiana K. Bronitch, Omaha, NE (US); Robin Dexter, Yardley, PA (US)

Correspondence Address: PATENT ADMINISTRATOR;FMC CORPORATION, 1735 MARKET STREET, PHILADELPHIA, PA, 19103, US

(73) Assignee: Innovaform Technologies, LLC, Philadelphia, PA (US)

(21) Appl. No.: 12/518,401

(22) PCT Filed: Dec. 13, 2007
(86) PCT No.: PCT/US07/87398

§ 371 Date: Jun. 9, 2009

Related U.S. Application Data
(60) Provisional application No. 60/874,465, filed on Dec. 13, 2006.

(51) Int. Cl. A01N 43/653; A01P 7/00; A01P 7/04

(52) U.S. Cl. 514/384

(57) ABSTRACT

In one aspect, this invention relates to a substantially water-insoluble pesticidal aggregate produced from a mixture comprising: (a) a polymer having at least three similarly charged electrostatic moieties; (b) an amphiphilic surfactant having at least one electrostatically charged moiety of opposite charge to the polymer; and (c) a pesticide. In other aspects, this invention relates pesticidal compositions comprising such a pesticidal aggregate and an agriculturally acceptable carrier, as well as to a method of controlling pests using such pesticidal compositions.

### CROSS REFERENCE RELATED APPLICATIONS

This application claims the benefit of U.S. Provisional Application No. 60/874,465, filed Dec. 13, 2006.

### FIELD OF THE INVENTION

In one aspect, this invention relates to a substantially water-insoluble pesticidal aggregate produced from a mixture comprising: (a) a polymer having at least three similarly charged electrostatic moieties; (b) an amphiphilic surfactant having at least one electrostatically charged moiety of opposite charge to the polymer; and (c) a pesticide. In other aspects, this invention relates to pesticidal compositions comprising such a pesticidal aggregate, as well as to a method of controlling pests using such pesticidal compositions.

### BACKGROUND OF THE INVENTION

There has long been a need in the agricultural field to control the movement of pesticidal active ingredients in the soil and other environments, as well as to control the rate at which such active ingredients are released. Pesticide compositions exhibiting controlled retention and/or release of the active pesticide can be used to reduce the amount and/or the frequency of applications of pesticide needed to effectively control pests, as well as to ensure that such active ingredients either transport to and/or remain in that portion of the environment where they can be most effective. The movement of pesticides in the environment depends on many factors, including rainfall, soil acidity and type, as well as plant tolerance.

Thus, one particular problem relating to certain pesticides is that they tend to ionize at the pH of the environment in which they are placed, increasing their solubility which causes them to move downward through the soil. This can result in a loss of pesticide in the location desired, diminishing the efficacy of the pesticide treatments.

Conversely other pesticides, particularly those which are hydrophobic, tend to remain stationary in the soil, with the result that they do not spread as desirably as possible through the desired location and necessitating that increased amounts of such pesticides be applied in order to achieve the desired control.

Accordingly, there is a need to develop improved formulations of pesticides which are capable of limiting the leaching of certain pesticides in soil without reducing their agricultural efficacy. Moreover, there is also a need to develop improved pesticide formulations which will increase the mobility of other pesticides in soil so that such pesticide is efficiently distributed throughout its desired range. These pesticide compositions must be able to be effective in a wide variety of soils of different pH levels.

Various solutions to the above problems have been proposed. However, there is still a need in the industry for improved controlled release formulations. Controlled release formulations have also been developed for pharmaceutical application. However, important differences between pharmaceutical and agricultural formulations arise because of the different environments for which the formulations are intended.

In pharmaceutical preparations, the formulation is typically administered by application to skin, by mouth or by injection. These environments are very specific and are closely controlled by the body. Permeation of the active ingredient through skin depends on the permeability of the skin, which is similar in most patients. Formulations taken by mouth are subject to different environments in sequence, e.g., saliva, stomach acid and basic conditions in the gut, before absorption into the bloodstream, yet these conditions are similar in each patient. Injected formulations are exposed to a different set of specific environmental conditions; still, these environments are similar in each patient. In formulations for all these environments, excipients are important to the performance of the active ingredient. Absorption, solubility, transfer across cell membranes are all dependent on the mediating properties of excipients. Therefore, formulations are designed for specific conditions and specific application methods, which are predictably present in all patients.

By contrast, in agricultural applications, an active ingredient may be used in similar formulations and similar application methods to treat many types of crops or pests. Environmental conditions vary greatly from one geographical area to another and from season to season. Agricultural formulations must be effective in a broad range of conditions, and this robustness must be built into a good agricultural formulation.

For agricultural compositions, the surface/air interface is much more important than for pharmaceutical compositions, which operate within the closed system of the body. In addition, agricultural environments contain different components such as clay, heavy metals, and different surfaces such as leaves (waxy hydrophobic structures). The temperature range of soil also varies more widely than the body, and may typically range between 0 and 54 degrees Celsius. The pH of soil can range from moderately acidic to strongly basic, while pharmaceutical compositions are typically formulated to release at the narrower pH bands associated with human physiology.

Application of agricultural formulations is often accomplished by spraying a water-diluted formulation directly onto the field either before or after emergence of the crop/weeds. Spraying has utility when the formulation must contact the leafy growing parts of a plant target. Frequently, dry granular formulations are used and are applied by broadcast spreading. These formulations are useful when applied before emergence of the crop and weeds. In such cases the active ingredient must remain in the soil, preferably localized in the region of the growing roots of the target plant or in the active region for the target pests.

It is an object of this invention to provide a pesticidal composition that limits the mobility of the pesticide in the soil and retains the pesticide in the root or immediate surrounding area of the soil where it is applied. In this regard, the composition preferably targets the top 1-3 inches of soil.

It is a further object of this invention to provide a pesticidal composition which increases the mobility of certain hydrophobic pesticides such that such pesticides efficiently disperse in that region of the environment in which they are effective.

Another object of this invention is to provide a pesticidal composition that allows for the use of pesticide in lower amounts, providing a more economically effective and environmentally friendly treatment.

Another object of this invention is to provide a pesticidal composition that is suitable for universal application to a wide range of different soil environments.

Another object of this invention is to provide a pesticidal composition that may be tailored to specific soil environment in order to control the soil mobility of the pesticide.

Yet another object of this invention is to provide a pesticidal composition which has improved foliar application.

### SUMMARY OF THE INVENTION

In one aspect, the present invention is directed to a substantially water insoluble pesticidal aggregate produced from a mixture comprising (a) a polymer having at least three similarly charged electrostatic moieties; (b) an amphiphilic surfactant having at least one electrostatically charged moiety of opposite charge to the polymer; and (c) a pesticide.

In another aspect, this invention is directed to a pesticidal composition comprising such pesticidal aggregate and an agriculturally acceptable carrier.

In yet another aspect, this invention is directed to a method of controlling pests comprising applying to the locus of such pests a pesticidally effective amount of such pesticidal composition.

### BRIEF DESCRIPTION OF THE DRAWINGS

FIG. 1 depicts the elution of sulfentrazone in soil.

FIG. 2 depicts the release of sulfentrazone from an insoluble aggregate.

### DEFINITIONS

Amphiphilic surfactant: A surfactant containing at least one ionic or ionizable group and at least one hyrdophobic group.

Backbone: Used in graft copolymer nomenclature to describe the chain onto which the graft is formed.

Block copolymer: A combination of two or more chains of constitutionally or configurationally different monomers linked in a linear fashion.

Branched polymer: A combination of two or more chains linked to each other, in which the end of at least one chain is bonded at some point along the other chain.

Chain: A polymer molecule formed by covalent linking of monomeric units.

Colloidal dispersion: A dispersion having an average particle size of between about 10 nm and about 10 microns.

Configuration: Organization of atoms along the polymer chain, which can be interconverted only by the breakage and reformation of primary chemical bonds.

Copolymer: A polymer that is derived from more than one species of monomer.

Cross-link: A structure bonding two or more polymer chains together.

Dendrimer: A regularly branched polymer in which branches start from one or more centers.

Dispersions: Particulate matter distributed throughout a continuous medium.

Graft copolymer: A combination of two or more chains of constitutionally or configurationally different features, one of which serves as a backbone main chain, and at least one of which is bonded at some points along the backbone and constitutes a side chain.

Homopolymer: Polymer that is derived from one species of monomer.

Link: A covalent chemical bond between two atoms, including bond between two monomeric units, or between two polymer chains.

Network strand: A polymer chain between the crosslinks.

Polyanion: A polymer chain containing repeating units containing groups capable of ionization in aqueous solution resulting in formation of negative charges on the polymer chain.

Polycation: A polymer chain containing repeating units containing groups capable of ionization in aqueous solution resulting in formation of positive charges on the polymer chain.

Polyion: A polymer chain containing repeating units containing groups capable of ionization in aqueous solution resulting in formation of positive or negative charges on the polymer chain.

Polymer: Homopolymers and copolymers as further described herein.

Polymer blend: An intimate combination of two or more polymer chains of constitutionally or configurationally different features, which are not linked to each other.

Polymer segment: A portion of polymer molecule in which the monomeric units have at least one constitutional or configurational feature absent from adjacent portions. Segments may be in the form of block or random copolymers.

Polymer network: A three dimensional polymer structure, where the chains are connected by cross-links or through physical interaction of the different polymer chains.

Random copolymer: A combination of two or more constitutionally or configurationally different monomers linked in a random fashion.

Repeating unit: Monomeric unit linked into a polymer chain.

Side chain: The grafted chain in a graft copolymer.

Star block copolymer: Three or more chains of different constitutional or configurational features linked together at one end through a central moiety.

Star polymer: Three or more chains linked together at one end through a central moiety.

Surfactant: Surface active agent that will migrate to the interface.

### DETAILED DESCRIPTION OF THE INVENTION

The pesticidal aggregates of the present invention are produced from a mixture comprising: (a) a polymer having at least three similarly charged electrostatic moieties; (b) an amphiphilic surfactant having at least one electrostatically charged moiety of opposite charge to the polymer; and (c) a pesticide. As is employed herein, the term aggregate refers to a complex which possesses an increased size relative to the individual components. In this regard, it is to be noted that many of the charged polymers which may be employed are water soluble to the extent that they represent molecular dispersions (true solutions). Once combined with the other components however, such polymers form aggregates.

While not wishing to be bound to the below theory, Applicants believe that surfactants can cooperatively bind to the polymers of opposite charge (see, for example, Goddard, In Interactions of Surfactants with Polymers and Proteins. Goddard and Ananthapadmanabhan, Eds., pp. 171 et seq., CRC Press, Boca Raton, Ann Arbor, London, Tokyo, 1992). Cooperative binding occurs if the binding of surfactant molecules to the polymer is enhanced by the presence of other molecules of this or other surfactant, which are already bound to the same polymer. Accordingly, the electrostatically charged moieties on the polymer component should be spaced closely enough together so that an aggregate is formed when such polymer is mixed with the other components described herein.

According to one embodiment of the present invention, a cationic amphiphilic surfactant binds electrostatically to oppositely charged anionic segments of the polymer to form aggregates. These aggregates are cooperatively stabilized by the interactions of the hydrophobic parts of surfactant molecules bound to the same anionic segment with each other.

Somewhat similarly, according to a second embodiment of the present invention, an anionic amphiphilic surfactant binds electrostatically to oppositely charged cationic segments of the polymer to form aggregates. These aggregates are cooperatively stabilized by the interactions of the hydrophobic parts of surfactant molecules bound to the same cationic segment with each other.

Formation of the electrostatic bonds between the charged surfactants and oppositely charged polymer chains results in charge neutralization (or at least partial charge neutralization). As a result, the hydrophobicity of the bonded segments increases and aqueous solubility decreases. Consequently, the aggregates produced by the reaction of the polymer, the amphiphilic surfactant and the pesticide are substantially water insoluble. As is employed herein, the term substantially water insoluble means that they form precipitates or colloidal dispersions in the presence of water.

The aggregates may be formed as precipitates or as stable colloidal dispersions, depending upon the particular components employed and the conditions under which they are combined. In those embodiments where a precipitate is formed, it is necessary to employ methods known in the art, for example the addition of additional surfactants and/or other formulation components to form a dispersion. In other embodiments, the aggregates themselves are formed as stable aqueous dispersions, although other formulation components may be added as well.

### Pesticide

Pesticides which may be employed in the aggregates of this invention include a wide range of herbicides, nematocides, insecticides, acaricides, fungicides, plant growth promoting or controlling chemicals and other crop treating products. One of ordinary skill in the art can find a listing of suitable pesticides by consulting references such as the Ashgate Handbook of Pesticides and Agricultural Chemicals, G. W. A. Milne (ed.), Wiley Publishers (2000). Combinations of two or more pesticides may also be employed.

One class of pesticides which may be preferably employed to form the aggregates of this invention contains at least one electrostatic charge in the environment in which they are used. Such pesticides may acquire positive electrostatic charge(s), negative electrostatic charge(s), or both. The ability to ionize depends on the chemical structure of the pesticide. Some ionize readily, such as quaternary ammonium salts, sulfates, sulfonates and other pesticides that are strong salts. Such compounds are ionized in a broad range of environmental pH. Other pesticides of this type which are useful in the invention can be either weak acids, weak bases or both, such as primary or secondary amino or carboxylic acids. Ionization of these weak acids or bases depends on environmental conditions such as pH, concentration of salt electrolytes, temperature and other parameters which are known to affect ionization. On the other hand, “strong” ionization does not depend on environmental pH.

One way to characterize the ability of a compound to ionize is by ionization constant. For example:
If pH equals pKa−1—approximately 10% of molecules are ionized
If pH equals pKa—50% of molecules are ionized
If pH equals pKa+1—approximately 90% of molecules are ionized.

The environmental pH affects the ionization of such compounds. Preferred pesticides for this embodiment are those which are ionized in the range of a pH of between about 2 and about 10, preferably of between about 3 and about 9, more preferably of between about 4.5 and about 9. The pesticide may carry one or more charges, where if the pesticide contains more than one charge, e.g., two charges, one charge may be positive and the other charge may be negative. However, the pesticides useful in forming the complexes of this invention should possess less than 10, and preferably possess less than 5 charges. The pesticide may have a combination of charges that are spatially distributed throughout the pesticide molecule. Ionized forms include acids e.g., NH₄⁺ and bases, e.g., COO⁻.

In this embodiment of the invention, the pesticide may have a charge which is the same as the polymer or opposite to the polymer. However, in order to obtain higher loadings, it has been found that complexes wherein the pesticide has the same charge as the polymer are preferred.

Another preferred embodiment involves pesticides containing hydrophobic groups. These pesticides may be charged or uncharged. The hydrophobicity of the pesticide is characterized by octanol/water partition coefficient expressed herein as log P. For uncharged pesticides the preferred log P is at least 1, more preferably at least 3, even more preferably at least 5 and most preferably at least 6. For charged pesticides the preferred log P is at least 0, more preferably at least 1.5, even more preferably at least 2.5 and most preferably at least 3.5.

Preferred classes of pesticidal compounds which may be employed to produce the aggregates of this invention include hydroxybenzonitrites, pyridinecarboxylic acids, triazolopyrimidines, benzoic acids employed include phenoxycarboxylic acids, diphenyl ethers, glycine derivatives, benzoylureas, anilides, imidazoliniones, triketones, sulfonylureas, dinitroanilines, phenoxypropionates, quarternary ammonium compounds, gibberellins, pyrethroids, triazolinones, acetanilides, triazines, benzoic acids, azoles, strobilurins, substituted benzenes, triazoles, carbamates and dinitroanilies. Particularly preferred pesticides include 2,4-D, bromoxynil, clopyralid, cloransulam-methyl, dicamba, fenhexamid, fomesafen, glyphosate, glufosinate, imazethapyr, mesotrione, nicosulfuron, oryzalin, paraquat, diquat, quizalofop-P, sulfentrazone, lufenuron, novaluron, gibberellic acid, bifenthrin, sulfentrazone, metoachlor, atrazine, alachlor, acetochlor, dicamba, flutriafol, azoxystrobin, chlorothalonil, tebuconazole, oxamyl and pendimethalin.

### Polymers

The polymers useful in the present invention contain at least three similarly charged electrostatic moieties. Such polymers may be or may contain polyion, polyanion, or polycation polymer segments. Alternatively, such polymers may be homopolymers, statistical copolymers or periodic copolymers having charged substituents provided that they possess the capability to form aggregates when mixed with the other components. These polymers or polymer segments independently of each other can be linear polymers, crosslinked polymers, randomly branched polymers, block copolymers, statistical copolymers, periodic copolymers, graft copolymers, star polymers, star block copolymers, dendrimers or have other architectures, including combinations of the above-listed structures. Polymers also include polyelectrolytes, polymers having at least three charges, preferably at least 10 charges, and more preferably at least 15 charges. Additionally, such polymeric component may contain non-ionic segments. The degree of polymerization of the polyion segments in the polymeric component is typically between about 10 and about 100,000. More preferably, the degree of polymerization is between about 10 and about 10,000, still more preferably, between about 10 and about 1,000.

In certain embodiments of this invention, particularly when a hydrophobic pesticide is employed, the charged polymers comprise additional nonionic hydrophilic moieties. Such polymers may comprise one or more nonionic hydrophilic segment and one or more polyionic segment. Alternatively, such polymers may be homopolymers, periodic copolymers or statistical copolymers having both nonionic hydrophilic and charged substituents so long as they possess the capability to form aggregates when mixed with the other components. These polymers or polymer segments independently of each other can be linear polymers, crosslinked polymers, randomly branched polymers, block copolymers, statistical copolymers, periodic copolymers, graft copolymers, star polymers, star block copolymers, dendrimers or have other architectures, including combinations of the above-listed structures.

The polymeric component may be long or short chain polymers. The polymeric component may also be partially crosslinked or in the form of a dispersion such as an emulsion, suspension, or the like. In some embodiments, a short chain polymeric component is preferable in order to obtain a better load and/or more control of the release properties of the pesticide.

Crosslinked polymers of the nanoscale size (from 20 nm to 600 nm) known in the art as crosslinked nanogels which contain water-soluble nonionic and ionic polymer chains are not employed in the practice of this invention. Such nanogels do not aggregate, and are designed to have a high bioavailability in the human body by crossing biological barriers.

Examples of polyanions and polyanion blocks and segments include but are not limited to polymers and their salts comprising units deriving from one or several monomers including: unsaturated ethylenic monocarboxylic acids, unsaturated ethylenic dicarboxylic acids, ethylenic monomers comprising a sulphonic acid group, their alkali metal, their ammonium salts. Examples of these monomers include acrylic acid, methacrylic acid, aspartic acid, alpha-acrylamidomethylpropanesulphonic acid, 2-acrylamido-2-methylpropanesulphonic acid, citrazinic acid, citraconic acid, trans-cinnamic acid, 4-hydroxy cinnamic acid, trans-glutaconic acid, glutamic acid, itaconic acid, fumaric acid, linoleic acid, linolenic acid, maleic acid, nucleic acids, trans-beta-hydromuconic acid, trans-trans-muconic acid, oleic acid, 1,4-phenylenediacrylic acid, phosphate 2-propene-1-sulfonic acid, ricinoleic acid, 4-styrene sulfonic acid, styrenesulphonic acid, 2-sulphoethyl methacrylate, trans-traumatic acid, vinylsulfonic acid, vinylbenzenesulphonic acid, vinyl phosphoric acid, vinylbenzoic acid and vinylglycolic acid and the like as well as carboxylated and sulphonated polysaccharides such as carboxylated dextran, sulphonated dextran, carboxylated cellulose, heparin and the like.

Polyanion blocks which may be employed have several ionizable groups that can form net negative charge. Preferably, the polyanion blocks will have at least about 3 negative charges, more preferably, at least about 6, still more preferably, at least about 12. The examples of polyanions include but are not limited to polymaleic acid, polyaspartic acid, polyglutamic acid, polylysine, polyacrylic acid, polymethacrylic acid, polyamino acids and the like. The polyanions and polyanion blocks can be produced by polymerization of monomers that themselves may not be anionic or hydrophilic, such as for example, tert-butyl methacrylate or citraconic anhydride, and then converted into a polyanion form by various chemical reactions of the monomeric units, for example hydrolysis, resulting in ionizable groups. The conversion of the monomeric units can be incomplete resulting in a copolymer having a portion of the units that do not have ionizable groups, such as for example, a copolymer of tert-butyl methacrylate and methacrylic acid.

The polyanionic segments can be a copolymer containing more than one type of monomeric units including a combination of anionic units with at least one other type of units including anionic units, cationic units, zwitterionic units, hydrophilic nonionic units or hydrophobic units. Such polyanions and polyanion segments can be obtained by copolymerization of more than one type of chemically different monomers. When such a copolymer is employed, the charged groups should be spaced close enough together so that, when reacted with the other components, an aggregate is formed.

Examples of polycations and polycation blocks and segments include but are not limited to polymers and copolymers and their salts comprising units deriving from one or several monomers including: primary, secondary and tertiary amines, each of which can be partially or completely quaternized forming quaternary ammonium salts. Examples of these monomers include cationic aminoacids (such as lysine, arginine, histidine), alkyleneimines (such as ethyleneimine, propyleneimine, butileneimine, pentyleneimine, hexyleneimine, and the like), spermine, vinyl monomers (such as vinylcaprolactam, vinylpyridine, and the like), acrylates and methacrylates (such as N,N-dimethylaminoethyl acrylate, N,N-dimethylaminoethyl methacrylate, N,N-diethylaminoethyl acrylate, N,N-diethylaminoethyl methacrylate, t-butylaminoethyl methacrylate, acryloxyethyltrimethyl ammonium halide, acryloxyethyldimethylbenzyl ammonium halide, methacrylamidopropyltrimethyl ammonium halide and the like), allyl monomers (such as dimethyl diallyl ammoniam chloride), aliphatic, heterocyclic or aromatic ionenes, cationic polysaccharides and the like.

Polycation blocks which may be employed have several ionizable groups that can form net positive charge. Preferably, the polycation blocks will have at least about 3 positive charges, more preferably, at least about 6, still more preferably, at least about 12. The polycations and polycation blocks and segments can be produced by polymerization of monomers that themselves may be not cationic, such as for example, 4-vinylpyridine, and then converted into a polycation form by various chemical reactions of the monomeric units, for example alkylation, resulting in appearance of ionizable groups. The conversion of the monomeric units can be incomplete resulting in a copolymer having a portion of the units that do not have ionizable groups, such as for example, a copolymer of vinylpyridine and N-alkylvinylpyridinuim halide.

Each of the polycations and polycation blocks can be a copolymer containing more than one type of monomeric units including a combination of cationic units with at least one other type of units including cationic units, anionic units, zwitterionic units, hydrophilic nonionic units or hydrophobic units. Such polycations and polycation blocks can be obtained by copolymerization of more than one type of chemically different monomers. When such a copolymer is employed, the charged groups should be spaced close enough together so that, when reacted with the other components, an aggregate is formed.

Examples of commercially available polycations include polyethyleneimine, polylysine, polyarginine, polyhistidine, polyvinyl pyridine and its quaternary ammonium salts, copolymers of vinylpyrrolidone and dimethylaminoethyl methacylate (Agrimer) and copolymers of vinylcaprolactam, vinylpyrrolidone and dimethylaminoethyl methacylate available from ISP, guar hydroxypropyltrimonium chloride and hydroxypropyl guar hydroxypropyltriammonium chloride (Jaguar) available from Rhodia, copolymers of 2-methacryloyl-oxyethyl phosphoryl choline and 2-hydroxy-3-methacryloyloxypropyltrimethylammonium chloride (Polyquaternium-64) available from NOF Corporation (Tokyo, Japan), N,N-dimethyl-N2-propenyl-chloride or N,N-Dimethyl-N2-propenyl-2-propen-1-aminium chloride (Polyquaternium-7), quaternized hydroxyethyl cellulose polymers with cationic substitution of trimethyl ammonium and dimethyldodecyl ammonium available from Dow, quaternized copolymer of vinylpyrrolidone and dimethylaminoethyl methacrylate (Polyquaternium-11), copolymers of vinylpyrrolidone and quaternized vinylimidazol (Polyquaternium-16 and Polyquaternium-44), copolymer of vinylcaprolactam, vinylpyrrolidone and quaternized vinylimidazol (Polyquaternium-46) available from BASF, quaternary ammonium salts of hydroxyethylcellulose reacted with trimethyl ammonium substituted epoxide (Polyquaternium-10) available from Dow, and chitisines.

The polyion-containing polymer may be a blend of two or more polymers of different structures, such as polymers containing different degrees of polymerization, backbone structures, and/or functional groups.

Examples of polyampholytes and polyampholyte blocks and segments include but are not limited to polymeric constituents comprising at least one type of units containing anionic ionizable group and at least one type of units containing cationic ionizable group derived from various combinations monomers contained in polyanions and polycations as described above. For example, polyampholytes include copolymers of [(methacrylamido)propyl]trimethylammonium chloride and sodium styrene sulfonate and the like. Each of the polyampholytes and polyampholyte segments can be a copolymer containing combinations of anionic and cationic units with at least one other type of units including zwitterionic units, hydrophilic nonionic units or hydrophobic units.

Zwitterionic polymers and polymer blocks and segments include but are not limited to polymeric components comprising units deriving from one or several zwitterionic monomers, including: betaine-type monomers, such as N-(3-sulfo-propyl)-N-methacryloylethoxyethyl-N,N-dimethylammonium betaine, N-(3-sulfopropyl)-N-methacrylamidopropyl-N,N-dimethylammonium betaine, phosphorylcholine-type monomers such as 2-methacryloyloxyethyl phosphorylcholine; 2-methacryloyloxy-2′-trimethylammoniumethyl phosphate inner salt, 3-dimethyl(methacryloyloxyethyl)ammoniumpropanesulfonate, 1,1′-binaphhthyl-2,2′-dihydrogen phosphate, and other monomers containing zwitterionic groups. The zwitterionic polymeric component can be a copolymer containing combinations zwitterionic units with at least one other type of units including anionic units, cationic units, hydrophilic nonionic units or hydrophobic units.

It is believed that the functional groups of polyanions, polycations, polyampholytes and some polyzwitterions can ionize or dissociate in an aqueous environment resulting in formation of charges in a polymer chain. The degree of ionization depends on the chemical nature of the ionizable monomeric units, the neighboring monomeric units present in these polymers, the distribution of these units within the polymer chain, and the parameters of the environment, including pH, chemical composition and concentration of solutes (such as nature and concentration of other electrolytes present in the solution), temperature, and other parameters. For example, polyacids, such as polyacrylic acid, are more negatively charged at higher pH and less negatively charged or uncharged at lower pH. The polybases, such as polyethyleneimine are more positively charged at lower pH and less positively charged or uncharged at higher pH. The polyampholytes, such as copolymers of methacrylic acid and poly((dimethylamino)-ethyl methylacrylate can be positively charged at lower pH, uncharged at intermediate pH and negatively charged at higher pH.

Without wishing to limit this invention to a specific theory it is generally believed that the appearance of charges in a polymer chain makes such polymer more hydrophilic and less hydrophobic and vice versa the disappearance of charges makes polymer more hydrophobic and less hydrophilic. Also, in general, the more hydrophilic the polymers are, the more water-soluble they are. In contrast, the more hydrophobic the polymers are, the less water-soluble they are. As a result, the aggregates produced by the reaction of the polymer, the amphiphilic surfactant and the pesticide are typically substantially water insoluble, although such aggregates may in some circumstances remain in a stable suspension rather than forming a precipitate in an aqueous environment.

Preferred polymers include styrene-acrylic copolymers, pentaerytritol ether cross-linked acrylic acid polymers, aqueous acrylic emulsions, linear polyacrylic acid polymers, sulfonated kraft lignin polymers, maleic anhydride/olefin copolymers, polystyrene sulfonic acid polymers and polyallylalkyl ammonium polymers. From a safety aspect, more preferred polymers include those approved by the United States Environmental Protection Agency for use in agricultural formulations. Such polymers can easily be identified by one of ordinary skill in the art by reviewing Inert (other) Pesticide Ingredients in Pesticide Products—Categorized List of Inert (other) Pesticide Ingredients available of the EPA website (www.EPA.gov). Particularly preferred polymers and copolymers include Metasperse 550S, Carbopol 71G, Carbopol Aqua 30, Polyquarternium 7, Sokalan PA 15, Sokalan PA 25 CLPN, Sokalan 30 CLPN, Sokalan PA 40, Sokalan PA 110s, REAX 88B, Geropon EGPM and poly(N,N-diallyl-N,N-dimethylammonium chloride).

In those embodiments wherein hydrophobic pesticides are employed, it is preferred that hydrophilic polymer segments comprise water-soluble polymers. The preferred nonionic polymer moieties are derived from polyethylene oxide, ethylene oxide/propylene oxide, a saccharide, acrylamide, gycerol, vinylalcohol, vinylpyrrolidone, vinylpyridine N-oxide, vinylpyridine N-oxide/vinylpyridine, oxazoline, or acroylmorpholine or derivatives thereof. In embodiments where a nonionic segment is present, in which the number of repeating units has a value of 3 or more.

From a safety aspect, more preferred polymers for use in this embodiment include those approved by the United States Environmental Protection Agency for use in agricultural formulations. Such polymers can easily be identified by one of ordinary skill in the art by reviewing Inert (other) Pesticide Ingredients in Pesticide Products—Categorized List of Inert (other) Pesticide Ingredients available of the EPA website (www.EPA.gov). Preferred polymers include poly[N,N-Dimethyl-N-2-propenyl-2-propen-1-ammonium chloride], poly(alkylene oxide)-block-poly(vinylpyridinium)copolymers, quaternized copolymers of vinylpyrrolidone and dimethylaminoethyl methacrylate, vinylpyrrolidone copolymers, methyl vinyl ether maleic anhydride ester copolymers and polyether polycarboxylates. Particularly preferred polymers include Polyquarternium 11, poly(ethylene oxide)-block-poly(N-ethyl-4-vinylpyridinium bromide), poly[N,N-Dimethyl-N2-propenyl-2-propen-1-ammonium chloride], Akzo PPEM 9376, Ethacryl P, Ethacryl M, Ethacryl G and Ethacryl HF.

### Surfactants

The aggregates of the invention are produced using at least one surfactant of opposite charge to the polymeric component. These surfactants are amphiphilic surfactants containing ionic or ionizable polar head group(s) and one or more hydrophobic groups. Suitable surfactants include those containing more than one head group, known as Gemini surfactants. Preferably, the surfactants are non-polymeric. The surfactant can be cationic or anionic (e.g., salts of fatty acids), and particularly charged forms will be chosen depending on the charge of the polymer.

Variation of the surfactant properties, such as in the length of the hydrophobic tail, will affect the stability of the aggregates. Mixtures of two or more surfactants having the same charge may be employed.

When cationic surfactants are to be employed, surfactants containing strong cations are preferred. Cationic surfactants suitable for use in the present compositions include primary amines (e.g., hexylamine, heptylamine, octylamine, decylamine, undecylamine, dodecylamine, pentadecyl amine, hexadecyl amine, oleylamine, stearylamine, diaminopropane, diaminobutane, diaminopentane, diaminohexane, diaminoheptane, diaminooctane, diaminononane, diaminodecane, diaminododecane), secondary amines (e.g., N,N-distearylamine), tertiary amines (e.g., N,N′,N′-polyoxyethylene(10)-N-tallow-1,3-diaminopropane), alkyl trimethyl quaternary ammonium salts, dialkyldimethyl quaternary ammonium, salts, ethoxylated quaternary salts (Ethoquads), e.g., dodecyltrimethylammonium bromide, hexadecyltrimethylammonium bromide, alkyltrimethylammonium bromide, tetradecyltrimethylammonium bromide, oleyltrimethylammonium chloride, benzalkonium chloride, cetyidimethylethylammonium bromide, dimethyldioctadecyl ammonium bromide, methylbenzethonium chloride, decamethonium chloride, methyl mixed trialkyl ammonium chloride, methyl trioctylammonium chloride, 1,2-diacyl-3-(trimethylammonio)propane (acyl group=dimyristoyl, dipalmitoyl, distearoyl, dioleoyl), 1,2-diacyl-3-(dimethylammonio)propane (acyl group=dimyristoyl, dipalmitoyl, distearoyl, dioleoyl), 1,2-dioleoyl-3-(4′-trimethylammonio) butanoyl-sn-glycerol, 1,2-dioleoyl-3-succinyl-sn-glycerol choline ester, cholesteryl (4′-trimethylammonio) butanoate), N-alkyl pyridinium and quinaldinium salts (e.g., cetylpyridinium halide, N-alkylpiperidinium salts, dialkyldimethylammonium salts, dicationic bolaform electrolytes (C₁₂Me₆; C₁₂ Bu₆), dialkylglycerylphosphorylcholine, lysolecithin), cholesterol hemisuccinate choline ester, lipopolyamines, e.g., dioctadecylamidoglycylspermine (DOGS), dipalmitoyl phosphatidylethanolamidospermine (DPPES), N′-octadecyl-sperminecarboxamide hydroxytrifluoroacetate, N′,N″-dioctadecylsperminecarboxamide hydroxytrifluoroacetate, N′-nonafluoropentadecylosperminecarboxamide hydroxytrifluoroacetate, N′,N″-dioctyl(sperminecarbonyl)glycinamide hydroxytrifluoroacetate, N′-(heptadecafluorodecyl)-N′-(nonafluoropentadecyl)-sperminecarbonyl)glycinamedehydroxytrifluoroacetate, N′-[3,6,9-trioxa-7-(2′-oxaeicos-11′-enyl)heptaeicos-18-enyl]-sperminecarbo xamide hydroxy-trifluoroacetate, N′-(1,2-dioleoyl-sn-glycero-3-phosphoethanoyl)spermine carboxamide hydroxytrifluoroacetate), 2,3-dioleyloxy-N-[2(spermine-carboxamido)ethyl]-N,N-dimethyl-1-propanamini umtrifluoroacetate (DOSPA), N,N^{I},N^{II},N^{III}-tetramethyl-N,N^{I},N^{II},N^{III}-tetrapalmitylspermine (TM-TPS), N-[1-(2,3-dioleyloxy)propyl]-N,N,N-trimethylamonium chloride (DOTMA), dimethyl dioctadecylammonium bromide (DDAB), 1,2-dioleoyl-3-dimethyl-hydroxyethyl ammonium bromide (DORI), 1,2-dioleyloxypropyl-3-dimethyl-hydroxyethyl ammonium bromide (DORIE), 1,2-dioleyloxypropyl-3-dimethyl-hydroxypropyl ammonium bromide (DORIE-HP), 1,2-dioleyloxypropyl-3-dimethyl-hydroxybutyl ammonium bromide (DORIE-HB), 1,2-dioleyloxypropyl-3-dimethyl-hydroxypentyl ammonium bromide (DORIE-HPe), 1,2-dimyristyloxypropyl-3-dimethyl-hydroxyethyl ammonium bromide (DMRIE), 1,2-dipalmitoyloxypropyl-3-dimethyl-hydroxyethyl ammonium bromide (DPRIE), 1,2-distearoyloxypropyl-3-dimethyl-hydroxyethyl ammonium bromide (DSRIE), N,N-dimethyl-N-[2-(2-methyl-4-(1,1,3,3-tetramethylbutyl)-phenoxy]ethoxy)ethyl]-benzenemethanaminium chloride (DEBDA), N-[1-(2,3-dioleyloxy)propyl]-N,N,N,-trimethylammonium methylsulfate (DOTAB), 9-(N′,N″-dioctadecylglycinamido)acridine, ethyl 4-[[N-[3-bis(octadecylcarbamoyl)-2-oxapropylcarbonyl]glycinamido]pyrrole-2-carboxamido]-4-pyrrole-2-carboxylate, N′,N′-dioctadecylornithylglycinamide hydroptrifluoroacetate, cationic derivatives of cholesterol (e.g., cholesteryl-3.beta.-oxysuccinamidoethylenetrimethylammonium salt, cholesteryl-3.beta.-oxy-succinamidoethylenedimethylamine, cholesteryl-3.beta.-carboxyamidoethylenetrimethyl-ammonium salt, cholesteryl-3.beta.-carboxyamidoethylenedimethylamine, 3.beta.[N—(N′,N′-dimethylaminoetane-carbomoyl]cholesterol), pH-sensitive cationic lipids (e.g., 4-(2,3-bis-palmitoyloxy-propyl)-1-methyl-1H-imidazole, 4-(2,3-bis-oleoyloxy-propyl)-1-methyl-1H-imidazole, cholesterol-(3-imidazol-1-yl propyl)carbamate, 2,3-bis-palmitoyl-propyl-pyridin-4-yl-amine) and the like.

When anionic surfactants are to be employed surfactants containing strong anions are preferred. Suitable anionic surfactants for use in the present compositions include alkyl sulfates, alkyl sulfonates, fatty acid soap including salts of saturated and unsaturated fatty acids and derivatives (e.g., arachidonic acid, 5,6-dehydroarachidonic acid, 20-hydroxyarachidonic acid, 20-trifluoro arachidonic acid, docosahexaenoic acid, docosapentaenoic acid, docosatrienoic acid, eicosadienoic acid, 7,7-dimethyl-5,8-eicosadienoic acid, 7,7-dimethyl-5,8-eicosadienoic acid, 8,11-eicosadiynoic acid, eicosapentaenoic acid, eicosatetraynoic acid, eicosatrienoic acid, eicosatriynoic acid, eladic acid, isolinoleic acid, linoelaidic acid, linoleic acid, linolenic acid, dihomo-γ-linolenic acid, γ-linolenic acid, 17-octadecynoic acid, oleic acid, phytanic acid, stearidonic acid, 2-octenoic acid, octanoic acid, nonanoic acid, decanoic acid, undecanoic acid, undecelenic acid, lauric acid, myristoleic acid, myristic acid, palmitic acid, palmitoleic acid, heptadecanoic acid, stearic acid, nonanedecanoic acid, heneicosanoic acid, docasanoic acid, tricosanoic acid, tetracosanoic acid, cis-15-tetracosenoic acid, hexacosanoic acid, heptacosanoic acid, octacosanoic acid, triocantanoic acid), salts of hydroxy-, hydroperoxy-, polyhydroxy-, epoxy-fatty acids, salts of carboxylic acids (e.g., valeric acid, trans-2,4-pentadienoic acid, hexanoic acid, trans-2-hexenoic acid, trans-3-hexenoic acid, 2,6-heptadienoic acid, 6-heptenoic acid, heptanoic acid, pimelic acid, suberic acid, sebacicic acid, azelaic acid, undecanedioic acid, decanedicarboxylic acid, undecanedicarboxylic acid, dodecanedicarboxylic acid, hexadecanedioic acid, docasenedioic acid, tetracosanedioic acid, agaricic acid, aleuritic acid, azafrin, bendazac, benfurodil hemisuccinate, benzylpenicillinic acid, p-(benzylsulfonamido)benzoic acid, biliverdine, bongkrekic acid, bumadizon, caffeic acid, calcium 2-ethylbutanoate, capobenic acid, carprofen, cefodizime, cefmenoxime, cefixime, cefazedone, cefatrizine, cefamandole, cefoperazone, ceforanide, cefotaxime, cefotetan, cefonicid, cefotiam, cefoxitin, cephamycins, cetiridine, cetraric acid, cetraxate, chaulmoorgic acid, chlorambucil, indomethacin, protoporphyrin IX, protizinic acid), prostanoic acid and its derivatives (e.g., prostaglandins), alkyl phosphates, O-phosphates (e.g., benfotiamine), alkyl phosphonates, natural and synthetic lipids (e.g., dimethylallyl pyrophosphate ammonium salt, S-farnesylthioacetic acid, farnesyl pyrophosphate, 2-hydroxymyristic acid, 2-fluorpalmitic acid, inositoltrphosphates, geranyl pyrophosphate, geranygeranyl pyrophosphate, .alpha.-hydroxyfarnesyl phosphonic acid, isopentyl pyrophoshate, phosphatidylserines, cardiolipines, phosphatidic acid and derivatives, lysophosphatidic acids, sphingolipids and like), synthetic analogs of lipids such as sodium-dialkyl sulfosuccinate (e.g., Aerosol OT®), n-alkyl ethoxylated sulfates, n-alkyl monothiocarbonates, alkyl- and arylsulfates (asaprol, azosulfamide, p-(benzylsulfonamideo)benzoic acid, cefonicid, CHAPS), mono- and dialkyl dithiophosphates, N-alkanoyl-N-methylglucamine, perfluoroalcanoate, cholate and desoxycholate salts of bile acids, 4-chloroindoleacetic acid, cucurbic acid, jasmonic acid, 7-epi jasmonic acid, 12-oxo phytodienoic acid, traumatic acid, tuberonic acid, abscisic acid, acitertin, and the like. Preferred cationic and anionic surfactants also include fluorocarbon and mixed fluorocarbon-hydrocarbon surfactants. Suitable surfactants include salts of perfluorocarboxylic acids (e.g., pentafluoropropionic acid, heptafluorobutyric acid, nonanfluoropentanoic acid, tridecafluoroheptanoic acid, pentadecafluorooctanoic acid, heptadecafluorononanoic acid, nonadecafluorodecanoic acid, perfluorododecanoic acid, perfluorotetradecanoic acid, hexafluoroglutaric acid, perfluoroadipic acid, perfluorosuberic acid, perfluorosebacicic acid), double tail hybrid surfactants (CₘF₂ₘ₊₁)(CₙH₂ₙ₊₁)CH——OSO₃Na, fluoroaliphatic phosphonates, fluoroaliphatic sulphates, and the like.

From a safety aspect, more preferred surfactants include those approved by the United States Environmental Protection Agency for use in agricultural formulations. Such surfactants can easily be identified by one of ordinary skill in the art by reviewing Inert (other) Pesticide Ingredients in Pesticide Products—Categorized List of Inert (other) Pesticide Ingredients available of the EPA website (www.EPA.gov).

Preferred surfactants include alkyltrimethylammonium bromides, alkyltrimethylammonium chlorides, alkyltrimethylammonium hydroxides, ethoxylated quarternary ammonium salts, alkylsulfates, alkylbenzene sulfonates and phosphate esters of tristyrylphenol. Particularly preferred surfactants include tetradecyltrimethyl ammonium bromide, hexadecyltrimethyl ammonium bromide, dodecyltrimethyl ammonium chloride, hexadecyltrimethylammonium chloride, octadecyltrimethylammonium chloride, cocoalkyltrimethylammonium chloride, tallowalkyltrimethyl ammonium chloride, cocoalkylmethyl[ethoxylated(2)]-ammonium nitrate, cocoalkylmethyl[ethoxylated(2)]-ammonium chloride, cocoalkylmethyl[ethoxylated(15)]-ammonium chloride, tris(2-hydroxyethyl)tallowalkylammonium acetate, oleylmethyl[ethoxylated(2)]-ammonium chloride, hydrogenated tallowalkyl (2-ethylhexyl)dimethyl ammonium sulfate, dicocoalkyldimethyl ammonium chloride, sodium dodecylsulfate, sodium dodecyl benzene sulfonate, phosphate esters of tristyrylphenol and sodium lauryl sulfate.

### Formation of the Aggregates

As will be recognized by one of ordinary skill in the art, there will be a need to optimize the particular combinations of surfactant and polymer for use with a given pesticide. In addition, there will be a need to optimize the conditions of forming the complexes therefrom, including varying the ratios of components added, the temperature at which the components are blended, the pH at which the components are blended, and other similar factors.

In general however, the charged polymer, surfactant, and pesticide may be added in any order to form the aggregates of the present invention. For example, the pesticide may be mixed with the polymer in the presence of water, and then later mixed with surfactant. The compositions of the invention may be formed by melt mixing the polymer, the pesticide, and the surfactant to form the aggregate. Alternatively, the compositions may be formed through mixing the components in an organic solvent, such as alcohol, heating the mixture for a time sufficient to dissolve the polymer and then evaporating the solvent to precipitate a solid aggregate. Also, the aggregate may be prepared as a suspension, whereby the pesticide and surfactant are added to an aqueous solution of the polymer with agitation. A solid aggregate may be obtained by separation, including by filtration or by freeze or spray drying.

The charge ratio of pesticide to polymer, and pesticide to surfactant may be varied in order to control the form and/or appearance of the aggregate as well as the uptake of pesticide in the aggregate. Charge ratios can easily be determined by multiplying the number of charges on a component by the number of moles of component employed; and then comparing this figure with that obtained for the other components. Preferably, charge ratios of between about 1:10 and about 10:1, more preferably of between about 1:5 and about 5:1, and most preferably of between about 3:1 and about 1:3 of polymer to surfactant are employed. Preferably, charge ratios of between about 1:10 and about 10:1, more preferably of between about 1:5 and about 5:1, and most preferably of between about 3:1 and about 1:3 of pesticide to surfactant are employed. Overall, most preferably stoichiometric charge ratios of all three components of the aggregates are employed.

In general, the polymers and surfactants used in the aggregates of this invention are selected to be suitable for the properties, such as the pKa or hydrophobicity of the pesticide in order to produce an aggregate and to produce the desired properties for a given application. The rate of release of the pesticide may also be changed through variation of the surfactant to polymer ratio and/or variation of pKa of polymer, and or through variation of the hydrophobicity of the surfactant. For example, the main factors influencing movement of pesticides include the pH of the soil, soil structure, soil composition in terms of organic and inorganic components, the particle size of the soil, and its mineral composition. Other factors include the solubility of the active ingredient, which is generally affected by pH and the pKa of the active ingredient. In addition, the solubility of the active ingredient also depends on its hydrophobicity. Adsorption of the pesticide decreases as the ionization of the pesticide and pH increases. Adsorption is influenced by the surface composition of the soils, especially its electrostatic charge. Similarly-charged soils and pesticides result in lower adsorption. The ionic strength of the water in the soil can also affect pesticide solubility and adsorption.

### Compositions

In one aspect, the present invention is directed to pesticidal compositions comprising the pesticidal aggregates described above. Typically, such compositions are comprised of the pesticidal aggregate and an agriculturally acceptable carrier. Such carriers are well know in the art and may be solids or liquids.

One skilled in the art will, of course, recognize that the formulation and mode of application of a pesticide may affect the activity of the material in a given application. Thus, for agricultural use, the present pesticidal aggregates may be formulated as a granular of relatively large particle size (for example, 8/16 or 4/8 US Mesh), as water-soluble or water-dispersible granules, as powdery dusts, as wettable powders, as emulsifiable concentrates, as aqueous emulsions, as solutions, or as any other known types of agriculturally-useful formulations, depending on the desired mode of application. They may be applied in the dry state (e.g., as granules, powders, or tablets) or they may be formulated as concentrates (e.g., solid, liquid, gel) that may be diluted to form stable dispersions (e.g., emulsions and suspensions).

### Concentrates

The compositions may be formulated as concentrates by techniques known to one of ordinary skill in the art. When the compositions are formulated as dry or liquid concentrates, the aggregate may form upon dilution or after application. If the composition is to be formulated as a solid, a filler such as Attaclay may be added to improve the rigidity of the granule. Due to the aggregates formed in the present composition, pesticide formulations may contain 30-40% load of the composition as opposed to 0-5% of other prior art compositions.

The pesticidal aggregates and pesticidal formulations may be stored and handled as solids which are dispersible into stable aqueous emulsions or dispersions prior to application. The dispersions allow uniform application from water. This is particularly advantageous at the field point of use, where normal admixing in water is all that is required before application.

The compositions of the present invention may also be in the form of wettable powders. Wettable powders are finely divided particles that disperse readily in water or other dispersant. The wettable powder is ultimately applied to the locus where pest control is needed either as a dry dust or as a dispersion in water or other liquid. Typical carriers for wettable powders include Fuller's earth, kaolin clays, silicas, and other highly absorbent, readily wet inorganic diluents. Wettable powders normally are prepared to contain about 5-80% of pesticide, depending on the absorbency of the carrier, and usually also contain a small amount of a wetting, dispersing or emulsifying agent to facilitate dispersion. For example, a useful wettable powder formulation contains 80.0 parts of the pesticidal compound, 17.9 parts of clay and 1.0 part of sodium lignosulfonate and 0.3 part of sulfonated aliphatic polyester as wetting agents. Additional wetting agent and/or oil will frequently be added to a tank mix to facilitate dispersion on the foliage of the plant.

Water-Dispersible Granules (WDG or DG) are dry compositions of the particulate pesticidal aggregate that will disperse in water yielding a dispersion of primary particles. Pesticide contents may range from 10-70% w/w. Polymers are used as dispersants (polyacrylate salts and lignosulfonate salts) and as binders to hold the granule together. Advantages of the dry product are that less potential for hydrolysis exists and high pesticide content may be achievable. Disadvantages are a more complex process involving milling blending extrusion and drying. Usually excipients are solids in this formulation.

Other useful formulations for the pesticidal compositions of the invention include emulsifiable concentrates, flowable formulations, and suspension concentrates. Emulsifiable Concentrates (EC) are solutions of pesticide in a water-immiscible solvent containing surfactants that cause the formulation to self emulsify when diluted in water. Pesticide contents range from 10-50% w/w and the formulations are pourable and easily emulsify in water. Emulsifiable concentrates (ECs) are homogeneous liquid compositions and may consist entirely of the pesticidal compound, polymer and a liquid or solid emulsifying agent, or may also contain a liquid carrier, such as xylene, heavy aromatic naphthas, isophorone, or other water-immiscible non-volatile organic solvents. The percentage by weight of the pesticide may vary according to the manner in which the composition is to be applied, but in general comprises 5% to 95% of pesticide by weight of the pesticidal composition. For pesticidal application, these concentrates are dispersed in water or other liquid carrier and normally applied as a spray to the area to be treated.

Flowable formulations are similar to ECs, except that they consist of particles of the pesticide complex suspended in a liquid carrier, generally water. Flowables, like ECs, may include a small amount of a surfactant as a wetting agent and dispersants that are generally anionic or nonionic, and will typically contain pesticides in the range of 5% to 95%, frequently from 10 to 50%, by weight of the composition. For application, flowables may be diluted in water or other liquid vehicle, and are normally applied as a spray to the area to be treated.

Suspension concentrates (SC) are dispersions of finely divided (2-15 micron) water-insoluble solid particles of the pesticide complex in water. Pesticide contents range from 8-50% w/w. They are pourable, easily dispersible in water and should be stable to settling in the package. Polymers such as xanthan gum are used to prevent settling by increasing the yield stress of the suspension. Some polymeric dispersants, such as polyacrylic acid salts, are used. The dispersions may be stabilized against flocculation by use of polymers such as methacrylate grafted with polyethylene glycol (Atlox). Ethylene oxide/propylene oxide copolymers may be used to provide some stabilization after dilution.

In addition, the concentrates may be formulated such that the aggregate is not present in the concentrate. Different techniques may be applied in order to delay the formation of the aggregates of the invention, including preparing the composition in the presence of a large excess of salt, organic solvent (both water miscible and immiscible), or an excess of amphiphilic surfactant. For example, salts may be added to delay the formation of the aggregate until dilution with water. Salts may be added to partially destroy the aggregate in order that a more stable dispersion may be formed. Without being limited to particular theory, it is believed that the added salt disrupts the electrostatic binding within the aggregate. In these embodiments, the aggregate forms upon dilution of the concentrate with water.

### Other Components

To the extent that the compositions contain other components, these components make up minor portions of the composition. Minor components may also include free pesticide, which has not been incorporated into the aggregate. In addition to the other components listed herein, compositions of this invention may also contain carriers, such as water or other solvents in amounts equal to or greater than the major components.

The pesticidal aggregates of this invention may be formulated and/or applied with one or more second compounds. Such combinations may provide certain advantages, such as, without limitation, exhibiting synergistic effects for greater control of pests, reducing rates of application of pesticide thereby minimizing any impact to the environment and to worker safety, controlling a broader spectrum of pests, resistance of crop plants to phytotoxicity, and improving tolerance by non-pest species, such as mammals and fish.

Second compounds include, without limitation, other pesticides, fertilizers, soil conditioners, or other agricultural chemicals. When the one or more second compounds are other pesticides such as herbicides, the herbicides include, for example: N-(phosphonomethyl)glycine (“glyphosate”); aryloxyalkanoic acids such as (2,4-dichlorophenoxy)acetic acid (“2,4-D”), (4-chloro-2-methylphenoxy)acetic acid (“MCPA”), (+/−)-2-(4-chloro-2-methylphenoxy)propanoic acid (“MCPP”); ureas such as N,N-dimethyl-N′-[4-(1-methylethyl)phenyl]urea (“isoproturon”); imidazolinones such as 2-[4,5-dihydro-4-methyl-4-(1-methylethyl)-5-oxo-1H-imidazol-2-yl]-3-pyridinecarboxylic acid (“imazapyr”), a reaction product comprising (+/−)-2-[4,5-dihydro-4-methyl-4-(1-methylethyl)-5-oxo-1H-imidazol-2-yl]-4-methylbenzoic acid and (+/−)2-[4,5-dihydro-4-methyl-4-(1-methylethyl)-5-oxo-1H-imidazol-2-yl]-5-methylbenzoic acid (“imazamethabenz”), (+/−)-2-[4,5-dihydro-4-methyl-4-(1-methylethyl)-5-oxo-1H-imidazol-2-yl]-5-ethyl-3-pyridinecarboxylic acid (“imazethapyr”), and (+/−)-2-[4,5-dihydro-4-methyl-4-(1-methylethyl)-5-oxo-1H-imidazol-2-yl]-3-quinolinecarboxylic acid (“imazaquin”); diphenyl ethers such as 5-[2-chloro-4-(trifluoromethyl)phenoxy]-2-nitrobenzoic acid (“acifluorfen”), methyl 5-(2,4-dichlorophenoxy)-2-nitrobenzoate (“bifenox”), and 5-[2-chloro-4-(trifluoromethyl)phenoxy]-N-(methylsulfonyl)-2-nitrobenzamide (“fomasafen”); hydroxybenzonitriles such as 4-hydroxy-3,5-diiodobenzonitrile (“ioxynil”) and 3,5-dibromo-4-hydroxybenzonitrile (“bromoxynil”); sulfonylureas such as 2-[[[[(4-chloro-6-methoxy-2-pyrimidinyl)amino]carbonyl]amino]sulfonyl]benzoic acid (“chlorimuron”), 2-chloro-N—[[(4-methoxy-6-methyl-1,3,5-triazin-2-yl)amino]carbonyl]benzenesulfonamide(achlorsulfuron”), 2-[[[[[(4,6-dimethoxy-2-pyrimidinyl)amino]carbonyl]amino]sulfonyl]methyl]benzoic acid (“bensulfuron”), 2-[[[[(4,6-dimethoxy-2-pyrimidinyl)amino]carbonyl]amino]sulfonyl]-1-methyl-1H-pyrazol-4-carboxylic acid (“pyrazosulfuron”), 3-[[[[(4-methoxy-6-methyl-1,3,5-triazin-2-yl)amino]carbonyl]amino]sulfonyl]-2-thiophenecarboxylic acid (“thifensulfuron”), and 2-(2-chloroethoxy)-N[[(4-methoxy-6-methyl-1,3,5-triazin-2-yl)amino]carbonyl]benzenesulfonamide (“triasulfuron”); 2-(4-aryloxy-phenoxy)alkanoic acids such as (+/−)-2[4-[(6-chloro-2-benzoxazolyl)oxy]phenoxy]-propanoic acid (fenoxaprop”), (+/−)-2-[4[[5-(trifluoromethyl)-2-pyridinyl]oxy]-phenoxy]propanoic acid (“fluazifop”), (+/−)-2-[4-(6-chloro-2-quinoxalinyl)oxy]-phenoxy]propanoic acid (“quizalofop”), and (+/−)-2-[(2,4-dichlorophenoxy)phenoxy]propanoic acid (“diclofop”); benzothiadiazinones such as 3-(1-methylethyl)-1H-1,2,3-benzothiadiazin-4(3H)-one-2,2-dioxide (“bentazone”); 2-chloroacetanilides such as N-(butoxymethyl)-2-chloro-N-(2,6-diethylphenyl)acetamide (“butachlor”), 2-chloro-N-(2-ethyl-6-methylphenyl)-N-(2-methoxy-1-methylethyl)acetamide (“metolachlor”), 2-chloro-N-(ethoxymethyl)-N-(2-ethyl-6-methylphenyl)acetamide (“acetochlor”), and (RS)-2-chloro-N-(2,4-dimethyl-3-thienyl)-N-(2-methoxy-1-methylethyl)acetamide (“dimethenamide”); arenecarboxylic acids such as 3,6-dichloro-2-methoxybenzoic acid (“dicamba”); pyridyloxyacetic acids such as [(4-amino-3,5-dichloro-6-fluoro-2-pyridinyl)oxy]acetic acid (“fluoroxypyr”), and other herbicides. When the one or more second compounds are other pesticides such as insecticides, the other insecticides include, for example: organophosphate insecticides, such as chlorpyrifos, diazinon, dimethoate, malathion, parathion-methyl, and terbufos; pyrethroid insecticides, such as fenvalerate, deltamethrin, fenpropathrin, cyfluthrin, flucythrinate, alpha-cypermethrin, bifenthrin, cypermethrin, resolved cyhalothrin, etofenprox, esfenvalerate, tralomehtrin, tefluthrin, cycloprothrin, betacyfluthrin, and acrinathrin; carbamate insecticides, such as aldecarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlorfluazuron, flucycloxuron, hexaflumuron, flufenoxuron, and lufenuron; and other insecticides, such as amitraz, clofentezine, fenpyroximate, hexythiazox, spinosad, and imidacloprid.

When the one or more second compounds are other pesticides such as fungicides, the fungicides include, for example: benzimidazole fungicides, such as benomyl, carbendazim, thiabendazole, and thiophanate-methyl; 1,2,4-triazole fungicides, such as epoxyconazole, cyproconazole, flusilazole, flutriafol, propiconazole, tebuconazole, triadimefon, and triadimenol; substituted anilide fungicides, such as metalaxyl, oxadixyl, procymidone, and vinclozolin; organophosphorus fungicides, such as fosetyl, iprobenfos, pyrazophos, edifenphos, and tolclofos-methyl; morpholine fungicides, such as fenpropimorph, tridemorph, and dodemorph; other systemic fungicides, such as fenarimol, imazalil, prochloraz, tricyclazole, and triforine; dithiocarbamate fungicides, such as mancozeb, maneb, propineb, zineb, and ziram; non-systemic fungicides, such as chlorothalonil, dichlofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides.

When the one or more second compounds are other pesticides such as nematicides, the nematicides include, for example: carbofuran, carbosulfan, turbufos, aldecarb, ethoprop, fenamphos, oxamyl, isazofos, cadusafos, and other nematicides.

When the one or more second compounds are other pesticides such as plant growth regulators, the plant growth regulators include, for example: maleic hydrazide, chlormequat, ethephon, gibberellin, mepiquat, thidiazon, inabenfide, triaphenthenol, paclobutrazol, unaconazol, DCPA, prohexadione, trinexapac-ethyl, and other plant growth regulators.

The one or more second compounds also include soil conditioners. Soil conditioners are materials which, when added to the soil, promote a variety of benefits for the efficacious growth of plants. Soil conditioners are used to reduce soil compaction, promote and increase effectiveness of drainage, improve soil permeability, promote optimum plant nutrient content in the soil, and promote better pesticide and fertilizer incorporation. The soil conditioners include organic matter, such as humus, which promotes retention of cation plant nutrients in the soil; mixtures of cation nutrients, such as calcium, magnesium, potash, sodium, and hydrogen complexes; or microorganism compositions which promote conditions in the soil favorable to plant growth. Such microorganism compositions include, for example, Bacillus, Pseudomonas, Azotobacter, Azospirillum, Rhizobium, and soil-borne Cyanobacteria.

The one or more second compounds also include fertilizers. Fertilizers are plant food supplements, which commonly contain nitrogen, phosphorus, and potassium. The fertilizers include nitrogen fertilizers, such as ammonium sulfate, ammonium nitrate, and bone meal; phosphate fertilizers, such as superphosphate, triple superphosphate, ammonium sulfate, and diammonium sulfate; and potassium fertilizers, such as muriate of potash, potassium sulfate, and potassium nitrate, and other fertilizers.

### Additional Surface Active Components

The compositions of the present invention may contain additional surface active compounds as dispersants. These dispersants may be different from and are in addition to the amphiphilic surfactant set forth above. Typical wetting, dispersing or emulsifying agents used in agricultural formulations include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 20% weight of the composition.

In addition to the amphiphilic surfactants and the dispersants set forth above, the pesticide compositions may additionally contain ionic, non-ionic or zwitterionic surfactants including but not limited to: phospholipids (e.g., phosphatidylethanolamines, phosphatidylglycerols, phosphatidylinositols, diacyl phosphatidyl-cholines, di-O-alkyl phosphatidylcholines, lysophosphatidylcholines, lysophosphatidylethanolamines, lysophosphatidylglycerols, lysophosphatidylinositols, and the like), saturated and unsaturated fatty acid derivatives (e.g., ethyl esters, propyl esters, cholesteryl esters, coenzyme A esters, nitrophenyl esters, naphtyl esters, monoglycerids, diglycerids, and triglycerides, fatty alcohols, fatty alcohol acetates, and the like), lipopolysaccharides, glyco- and shpingolipids (e.g. ceramides, cerebrosides, galactosyldiglycerids, gangliosides, lactocerebrosides, lysosulfatides, psychosines, shpingomyelins, sphingosines, sulfatides), chromophoric lipids (neutral lipids, phospholipids, cerebrosides, sphingomyelins), cholesterol and cholesterol derivatives, n-alkylphenyl polyoxyethylene ether (Tergitol XD, polyethylene glycol p-nonylphenyl ether), n-alkyl polyoxyethylene ethers (e.g., Triton™), sorbitan esters (e.g., Span™), polyglycol ether surfactants (Tergitol™), polyoxy-ethylenesorbitan (e.g., Tween™), polysorbates, polyoxyethylated glycol monoethers (e.g., Brij™, polyoxyethylene 9 lauryl ether, polyoxyethylene 10 ether, polyoxyethylene 10 tridecyl ether), lubrol, copolymers of ethylene oxide and propylene oxide (e.g., Pluronic™, Pluronic R™, Tetronic™, Pluradot™), alkyl aryl polyether alcohol (Tyloxapol™), perfluoroalkyl polyoxylated amides, N,N-bis[3-D-gluconamido-propyl]cholamide, decanoyl-N-methylglucamide, n-decyl-β-D-glucopyranozide, n-decyl-β-D-glucopyranozide, n-decyl-β-D-maltopyranozide, n-dodecyl-β-D-glucopyranozide, n-undecyl-β-D-glucopyranozide, n-heptyl-β-D-glucopyranozide, n-heptyl-β-D-thioglucopyranozide, n-hexyl-β-D-glucopyranozide, n-nonanoyl-β-D-glucopyranozide 1-monooleyl-rac-glycerol, nonanoyl-N-methylglucamide, n-dodecyl-α-D-maltoside, n-dodecyl-β-D-maltoside, N,N-bis[3-gluconamidepropyl]deoxycholamide, diethylene glycol monopentyl ether, digitonin, heptanoyl-N-methylglucamide, heptanoyl-N-methylglucamide, octanoyl-N-methylglucamide, n-octyl-β-D-glucopyranozide, n-octyl-α-D-glucopyranozide, n-octyl-β-D-thiogalactopyranozide, n-octyl-β-D-thioglucopyranozide, betaine (R₁R₂R₃N⁺R′CO₂⁻, where R₁R₂R₃R′ hydrocarbon chains), sulfobetaine (R₁R₂R₃N⁺R′SO₃⁻), phoshoplipids (e.g. dialkyl phosphatidylcholine), 3-[(3-cholamidopropyl)-dimethylammonio]-2-hydroxy-1-propanesulfonate, 3-[(3-cholamidopropyl)-dimethylammonio]-1-propanesulfonate, N-decyl-N,N-dimethyl-3-ammonio-1-propanesulfonate, N-dodecyl-N,N-dimethyl-3-ammonio-1-propanesulfonate, N-hexadecyl-N,N-dimethyl-3-ammonio-1-propanesulfonate, N-octadecyl-N,N-dimethyl-3-ammonio-1-propane-sulfonate, N-octyl-N,N-dimethyl-3-ammonio-1-propanesulfonate, N-tetradecyl-N,N-dimethyl-3-ammonio-1-propanesulfonate, and dialkyl phosphatitidyl-ethanolamine.

Other excipients useful in the present invention include: Tri styryl phenol ethoxylates, sulfates and phosphates in acid form or as Na or NH₄ salts; Castor oil ethoxylates with ethoxylation ranges 4-60; Sorbitan mono, di and tri-alkyl ethoxylates; Glyceryl trialkylates; Alkyl ethoxylates; Alkyl aryl sulfonate salts Na, Ca; Sorbitan Oleates; and Alky polyglucosides.

### Method of Controlling Pests

In a further aspect, this invention is directed to a method of controlling pests comprising applying to the locus of such pests a pesticidally effective amount of the pesticidal compositions described herein. Such locus may be where pests are present or are likely to become present.

In applying the compositions of this invention, whether formulated alone or with other agricultural chemicals, an effective amount and concentration of the active compound is of course employed; the amount may vary in the range of, e.g. about 0.001 to about 3 kg/ha, preferably about 0.03 to about 2 kg/ha. For field use, where there are losses of pesticide, higher application rates (e.g., four times the rates mentioned above) may be employed.

The pesticidal compositions of this invention may be applied either as water-diluted sprays, or dusts, or granules to the areas in which suppression of pests is desired. These formulations may contain as little as 0.1% to as much as 35% or more by weight of pesticide. Concentrates may be diluted in water, e.g., 100-1000 times, to form stable aqueous dispersion, e.g., stable for 24 hours. When diluted, it is preferred that the average particle size of the aggregate is less than about 50 microns, and more preferably less than about 20 microns, in order to facilitate application through spray nozzles.

The compositions of the present invention may be formulated as dusts. Dusts are free flowing admixtures of the pesticide compositions of the invention with finely divided solids such as talc, natural clays, kieselguhr, flours such as walnut shell and cottonseed flours, and other organic and inorganic solids which act as dispersants and carriers for the pesticide. These finely divided solids have an average particle size of less than about 50 microns. A typical dust formulation useful herein is one containing 1.0 part or less of the pesticidal composition and 99.0 parts of talc.

Different application methods are used for the pesticide formulations depending on the target pest, e.g., weed, fungus, or insect, and on the type of crop being treated. Application of pesticide may be by spraying solutions, emulsions or dispersions of finely divided pesticide complex to achieve accurate and even concentration over the entire treated area or target. Usually, the water used to dilute the pesticide composition in the spray mixture amounts to approximately 5-80 gallons per acre and the active ingredient amount may range approximately from 20 to 1000 grams per acre.

Pesticides may also be applied by broadcast spreading of granular formulations using machinery to achieve even distribution over the entire target. The pesticidal aggregate may be incorporated into granular formulations by using a sticker (additional surfactant, polymer solution, or latex) to attach the pesticide to an inert support. Other granules are prepared by extrusion of powdered pesticide complex with inert powdered ingredients, water, binders, and dispersants to form granules that are subsequently dried. Pre-formed granular supports are often used to absorb liquid pesticide or solutions of the pesticide.

Formulations of these types are normally used to deliver pesticides to the soil before emergence of the crop. The target may be weed seeds or insects residing at different depths in the soil. There are two types of water used in the formulation and application of the compositions of the invention. The first is the water used to dilute the concentrates for application. The second type of water is the water that interacts with the complex after application. This water includes water from the environment such as rain water or water from irrigation systems. Movement of the pesticide through the soil is generally affected and controlled by rainfall. Generally, the pesticide composition is dissolved in water originating from a spray solution or from rainfall.

The components of the aggregates may be shipped separately and mixed prior to use. Each component may be individually shipped or two of the components may be mixed and shipped together. For example, the polymer and pesticide may be mixed and shipped separately from the surfactant. The surfactant may be added to a mixture of polymer and pesticide just prior to application in order to form the aggregate. Alternatively, the aggregate may form in situ after application has been completed.

### Application Forms

Emulsions (EW) are emulsions of the pesticidal aggregate in water. If a solid form of the pesticidal aggregate is used, it is dissolved in a water-immiscible solvent before emulsification in water. Pesticide contents may range from 2-20% w/w. They are liquid, pourable and should be stable against settling in the package. Copolymers of ethylene oxide and propylene oxide may be used to prepare the emulsion and as stabilizers to prevent coalescence. Atlox comb-type polymers may also be used.

Microcapsule Suspensions (CS) are suspended particles of pesticidal aggregate or droplets of pesticidal agregate in solvent that are enclosed in a shell of water insoluble material, e.g., cross-linked polymer, and usually a charged dispersant or stabilizer against aggregation, dispersed in water. The shell is usually a cross linked polymer formed by interfacial polymerization, though other procedures are known. Polymers are used as dispersants (polyvinyl alcohols, lignosulfonate salts and PVP grafted with butyl) and also as stabilizers. Xanthan gums are used as thickeners to prevent settling.

Spray-Dried Formulations. These are generally dry products which may be powders or granules. Various liquid formulations may be amenable to spray drying (or specifically designed formulations may be formed for the spray drying process). For example SC formulations may be spray dried to dry powders. EW formulations may be modified with water-soluble polymers and spray dried. These result in a matrix particle with droplets of the emulsion in a matrix of the water soluble polymer. The powders disperse in water as the polymer dissolves. Polymers that are useful as matrices are polyacrylate salts, dextran, malto-dextrin, starches, and sugars.

Useful formulations for pesticidal applications include simple solutions of the pesticide complexes in a solvent in which it is completely soluble at the desired concentration, such as propylene glycol or propylene carbonate or mixtures with water. Other useful formulations include suspensions of the pesticidal aggregate in a relatively non-volatile solvent such as water, corn oil, kerosene, propylene glycol, or other suitable solvents. Granular formulations, wherein the pesticidal aggregate is carried on relative coarse particles, are of particular utility for aerial distribution or for penetration of cover crop canopy. Pressurized sprays, typically aerosols wherein the pesticidal aggregate is dispersed in finely divided form as a result of vaporization of a low-boiling dispersant solvent carrier may also be used. Water-soluble or water-dispersible granules are free flowing, non-dusty, and readily water-soluble or water-miscible. In use by the farmer on the field, the granular formulations, emulsifiable concentrates, flowable concentrates, aqueous emulsions, solutions, etc., may be diluted with water to give a concentration of pesticide in the range of e.g., 0.2-2%.

### EXAMPLES

The following examples further illustrate the present invention, but should not be construed as in any way limiting its scope. The examples are organized to present protocols for the preparation of the complexes of the present invention, set forth a list of such formulated species, and set forth certain data from empirical models indicating the efficacy of such aggregates.

### Example 1 and Comparative Experiments A and B

A 10% solution of sulfentrazone was prepared by dissolving sulfentrazone in 1 equivalent of sodium hydroxide solution and stirring overnight. 3.87 grams (1 equivalent) of sulfentrazone in such a solution was placed into a 20 mL glass vial and 0.94 grams of Sokalan PA-15 (linear polyacrylic acid sodium salt with low molecular weight of 1200 g/mol) was added. The mixture was stirred at room temperature using a vortex mixer. 2 equivalents (6.9 grams) of Arquad 18/50 octadecyltrimethyl ammonium chloride (aqueous isopropanol solution) were added and the mixture was stirred using a vortex mixer. Mixing of the cationic surfactant with the anioinic polymer and the anionic pesticide resulted in the formation of a precipitate calculated to contain 73% of the sulfentrazone (as calculated by the procedure described in Example 2).

The process above for Example 1 was repeated except that only 1 equivalent of sulfentrazone and 1 equivalent of Sokalan PA-15 were mixed (Comparative Experiment A). No precipitate was formed in the absence of the cationic surfactant.

The process above for Example 1 was repeated except that only 1 equivalent of sulfentrazone and 1 equivalent of Arquad 18/50 were mixed (Comparative Experiment B). No precipitate was formed, even though the pesticide is anionic and the surfactant is cationic.

### Comparative Experiment C

### Mixture of Sulfentrazone with Cationic Polymer

Sulfentrazone was reacted with cationic polymer Polyquarternium 7, poly[(N,N-dimethyl-N2-propenyl-2-propen-1-aminium chloride)]. 0.39 ml of sulfentrazone solution (10%, pH 11) was mixed with 0.7 ml of a 10% solution of Polyquarternium 7. The resulting mixture remained clear and no phase separation was observed. The concentration of sulfentrazone in the mixture was determined by UV-spectroscopy using a molar extinction coefficient of 16750 mol⁻¹cm⁻¹ L for sulfentrazone at λ=261 nm. The blank solution with the same concentration sulfentrazone but without polymer added was prepared as a control. For UV measurements both control and blank solutions were diluted to concentration of sulfentrazone of 0.002%, w/w, and their absorbance UV-spectra were recorded. All sulfentrazone added to the mixture remained quantitatively in the solution in unbound form.

This Comparative Experiment shows that no aggregate was formed, even though the pesticide is anionic and the polymer is cationic.

### Comparative Experiment D

### Sulfentrazone Plus Polymer without the Presence of Surfactant

Sulfentrazone was reacted with Sokalan PA 110S, linear polyacrylic acid sodium salt with high molecular weight of 250 000 g/mol. 0.5 ml of sulfentrazone solution (2%, pH 11) was mixed with 0.26 ml of Sokalan PA 110S aqueous solution (1%, pH 8.5). The resulting mixture remained clear and no phase separation was observed. The concentration of sulfentrazone in the mixture was determined by UV-spectroscopy using a molar extinction coefficient of 16750 mol⁻¹cm⁻¹ L for sulfentrazone at λ=261 nm. The blank solution with the same concentration sulfentrazone but without polymer added was prepared as a control. For UV measurements both control and blank solutions were diluted to concentration of sulfentrazone of 0.002%, w/w, and their absorbance UV-spectra were recorded. All sulfentrazone added to the mixture remained quantitatively in the solution in unbound form.

This Comparative Experiment shows that no aggregate was formed in the absence of cationic surfactant.

### Example 2

### Preparation of an Aggregate of Atlox Metasperse, Sulfentrazone, and Tetradecyltrimethylammonium Bromide

0.125 mL of aqueous solution of Atlox Metasperse 550S (10%), hydrophobized sodium salt of polyacrylic acid, was mixed with 4.45 mL of sulfentrazone solution (1%, pH 11.6), and 3.84 mL of water. The pH of the resulting mixture was about 10. 0.69 mL of tetradecyltrimethylammonium bromide solution (10%) was added to the alkali mixture prepared upon stirring. A complete coagulation of the white precipitate and clearance of the solution was observed in ca. 3 hours of stirring. Wet precipitate containing tertiary complex of polymer, surfactant and sulfentrazone was isolated by centrifugation at 15,000 g for 5 min. The concentration of sulfentrazone in supernatant was determined by UV-spectroscopy using a molar extinction coefficient of 16750 mol⁻¹cm⁻¹ L for sulfentrazone at λ=261 nm. For UV measurements both control and blank solutions were diluted to concentration of sulfentrazone of 0.002%, w/w, and their absorbance UV-spectra were recorded.

The uptake of sulfentrazone into the aggregate was calculated using the absorbance data according the equation (1):

$$Uptake = \frac{{C ( SFT )}_{init} - {C ( SFT )}_{super}}{{C ( SFT )}_{init}} * 100 \% , \qquad ( 1 )$$

as the difference between the initial concentration of sulfentrazone added (C(SFT)ᵢₙᵢₜ) and the final concentration of sulfentrazone in the supernatant (C(SFT)ₛᵤₚₑᵣ), and expressed as a percentage of the initial concentration. The uptake of sulfentrazone into the Atlox Metasperse 550S/tetradecyltrimethylammonium bromide aggregate was calculated to be 62%.

The loading (L) was defined as w/w % of sulfentrazone in the aggregate and was calculated according to the formula:

$$L = \frac{{m ( SFT )}_{prec} ,}{{m ( SFT )}_{prec} + m ( Atlox ) + m ( {C}_{14} NBr ) - m ( {Na}^{+} ) - m ( {Br}^{-} )} 100 \% , \qquad ( 2 )$$

where m(SFT)_{prec}. is the weight of sulfentrazone incorporated into the aggregate and calculated as a difference between the amount of sulfentrazone added to the reacting solution and the amount remaining in the supernatant, m(Atlox) is the weight of polymer, m(C14NBr) is the weight of surfactant, m(Na⁺) and m(Br⁻) are the weights of the counterions released upon the formation of the aggregate. The loading of sulfentrazone in the aggregate was 30 w/w %. No changes in sulfentrazone loading within 1 week were observed.

This example confirms that stable aggregates may be formed by mixing acrylate polymer, pesticide, and surfactant.

### Example 3

### Preparation of Aggregates of Atlox Metasperse 550S, Sulfentrazone, and Tetradecyltrimethylammonium Bromide at Different Concentrations of Polymer and Surfactant

Aggregates of sulfentrazone were prepared using Atlox Metasperse 550S polymer and tetradecyltrimethylammonium bromide mixtures. The sulfentrazone concentration in the mixtures was kept constant and was 0.5%. Polymer and surfactant concentrations in the mixtures were varied to obtain aggregates with maximal uptake of sulfentrazone. The concentrations of reagents in weight % in the mixtures are presented in the following Table 1. The aggregates were obtained and separated following the procedure described in Example 2. The concentrations of sulfentrazone in the supernatants were determined using UV-spectroscopy. The calculated values of sulfentrazone uptake in the aggregates prepared are summarized in the Table 1. These data demonstrate that increase of polymer/surfactant content in the mixture leads to an increase of the amount of sulfentrazone incorporated into the aggregate.

TABLE 1

| | | | Uptake of sulfentrazone |
|---|---|---|---|
| Atlox 550S | C14NBr | Sulfentrazone | in the aggregate (w/w %) |
| 0.075 | 0.5 | 0.5 | 74 |
| 0.15 | 0.7 | 0.5 | 83 |
| 0.25 | 0.75 | 0.5 | 77 |
| 0.5 | 1.25 | 0.5 | 90 |

### Example 4

### Preparation of an Aggregate of Carbopol 71 G Sulfentrazone, and Tetradecyltrimethylammonium Bromide

1 mL of 0.1% aqueous solution of Carbopol 71 G, a lightly cross-linked high molecular mass polyacrylic acid, was mixed with 0.12 mL of sodium hydroxide solution (0.1 M) and 1.5 mL of sulfentrazone solution (0.5%, pH 11), was added. The pH of the resulting mixture was about 10. 0.09 mL of tetradecyltrimethylammonium bromide solution (10%) was added to the alkali mixture prepared upon stirring. A complete coagulation of the white precipitate and clearance of the solution was observed in ca. 3 hours of stirring. Wet precipitate containing tertiary aggregate of polymer, surfactant and sulfentrazone was isolated by centrifugation at 15,000 g for 5 min. The concentration of sulfentrazone in supernatant was determined by UV-spectroscopy as described in Example 2. The loading of sulfentrazone in the tertiary aggregate was 38.5 w/w %.

These results demonstrate that aggregates of cross-linked acrylate copolymer, pesticide, and surfactant can be formed.

### Example 5

### Preparation of an Aggregate of Carbopol Aqua 30 Sulfentrazone, and Tetradecyltrimethylammonium Bromide

Aggregates of sulfentrazone were prepared using Carbopol Aqua 30 polymer and tetradecyltrimethylammonium bromide mixtures. Carbopol Aqua 30 is a cross-linked polyacrylic acid prepared by inverse emulsification polymerization and exists as a dispersion of swollen polymer particles of diameter in the range from 100 to 500 nm depending upon pH. 0.06 mL of aqueous dispersion (10%) of Carbopol Aqua 30 were mixed with 0.088 mL of sodium hydroxide solution (0.1 M) and 0.75 mL of sulfentrazone solution (2%, pH 11), was added. The pH of the resulting mixture was about 10. 0.225 mL of tetradecyltrimethylammonium bromide solution (10%) and 0.377 mL of water were added to the alkali mixture prepared upon stirring. The precipitate of aggregate was separated and supernatant was analyzed as described in Example 2. The uptake of sulfentrazone into insoluble Carbopol Aqua 30/tetradecyltrimethylammonium bromide aggregate was calculated to be 90%.

This example shows that crosslinked polymers may be used to form the aggregates of the invention.

### Example 6

### Preparation of an Aggregates of Polymers of Different Molecular Weights, Sulfentrazone, and Tetradecyltrimethylammonium Bromide

Aggregates of sulfentrazone were prepared using linear polyacrylic acid sodium salt and tetradecyltrimethylammonium bromide mixtures. A series of polymers with various molecular weights (Sokalan PA series from BASF) were used. 0.06 mL of aqueous solution (10%) of corresponding Sokalan polymer was mixed with 0.75 mL of sulfentrazone solution (2%, pH 11). The pH of the resulting mixture was about 10. 0.225 mL of tetradecyltrimethylammonium bromide solution (10%) and 0.377 mL of water were added to the alkali mixture prepared upon stirring. The sulfentrazone concentration in the mixtures was kept constant and was 1%. Aggregates were obtained and separated following the procedure described in Example 2. The concentrations of sulfentrazone in the supernatants were determined using UV-spectroscopy. The calculated values of sulfentrazone uptake in the aggregates prepared are summarized in the Table 2.

TABLE 2

| | | Molecular Weight | Uptake of sulfentrazone |
|---|---|---|---|
| | | (Degree of | in the aggregate |
| | Polymer | polymerization) | (w/w %) |
| 6A | Sokalan PA-15 | 1200 (13) | 90 |
| 6B | Sokalan PA 25 | 4000 (50) | 82 |
| | CLPN | | |
| 6C | Sokalan PA 30 | 8000 (100) | 87 |
| | CLPN | | |
| 6D | Sokalan PA 40 | 15 000 (160) | 86 |
| 6E | Sokalan PA 110S | 250 000 (3500) | 84 |

This example shows the relationship between molecular weight of the polymers used and the uptake of pesticide in the aggregate. Smaller molecular weights result in greater uptake of sulfentrazone into the aggregate.

### Example 7

### Preparation of an Aggregate of Polyacrylic Acid, Sulfentrazone, and Tetradecyltrimethylammonium Bromide

An aggregate of sulfentrazone was prepared using linear polyacrylic acid (MW 250,000, Sigma) and tetradecyltrimethylammonium bromide surfactant. 0.037 mL of aqueous solution (1.94%) of polyacrylic acid was mixed with 0.05 mL of sodium hydroxide (0.2 M) and 0.456 mL of sulfentrazone solution (1.3%, pH 11.7). The pH of the resulting mixture was about 10. 0.02 mL of tetradecyltrimethylammonium bromide solution (18.3%) and 1.437 mL of water were added to the alkali mixture prepared upon stirring. An aggregate was formed and was separated following the procedure described in Example 2. The concentration of sulfentrazone in the supernatant was determined using UV-spectroscopy. The calculated values of sulfentrazone uptake and loading in the aggregate were 58.75% and 43.3%, respectively.

This example shows the amount of sulfentrazone uptake in other larger polymers such as linear acrylic acid.

### Example 8

### Preparation of Aggregates of Various Concentrations of Sulfonated Lignin Polymer, Sulfentrazone, and Tetradecyltrimethylammonium Bromide

Aggregates of sulfentrazone were prepared using REAX 88B polymer and tetradecyltrimethylammonium bromide surfactant (C14NBr). REAX 88B is the sodium salt of a low molecular weight, highly sulfonated kraft lignin polymer. The sulfentrazone concentration in the mixtures was kept constant and was 0.5%. Polymer and surfactant concentrations in the mixtures were varied to obtain aggregates with maximal uptake of sulfentrazone. The concentrations of reagents in weight % in the mixtures are presented in the following Table 3. The aggregates were obtained and separated following the procedure described in Example 2. The concentrations of sulfentrazone in the supernatants were determined using UV-spectroscopy. The calculated values of sulfentrazone uptake in the aggregates prepared are summarized in the Table 3.

TABLE 3

| | | | Uptake of sulfentrazone in the |
|---|---|---|---|
| REAX 88B | C14NBr | Sulfentrazone | aggregate (w/w %) |
| 0.25 | 0.6 | 0.5 | 82 |
| 0.30 | 0.8 | 0.5 | 92 |
| 0.5 | 1.0 | 0.5 | 94 |

These data demonstrate that increasing the polymer/surfactant content in the mixture leads to an increase of the amount of sulfentrazone incorporated into the aggregate.

### Example 9

### Preparation of Aggregates of Polymers, Sulfentrazone, and Hexadecyltrimethylammonium Bromide

Aggregates of sulfentrazone were prepared using hexadecyltrimethylammonium bromide as the surfactant component, and Atlox Metasperse 550S or Carbopol Aqua 30 as the polymer component. The sulfentrazone concentration in the mixtures was kept constant and was 0.5%. The concentrations of polymer and surfactant in the mixtures were 0.2% and 0.8%, respectively. The stock solution of surfactant was warmed to ensure complete dissolution of the surfactant prior to mixing. The aggregates were obtained and separated following the procedure described in Example 2. The concentrations of sulfentrazone in the supernatants were determined using UV-spectroscopy. The calculated values of sulfentrazone uptake in the aggregates prepared are summarized in the Table 4.

TABLE 4

| | | Uptake of sulfentrazone in the |
|---|---|---|
| | Polymer | aggregate (w/w %) |
| 9A | Atlox Metasperse 550S | 87 |
| 9B | Carbopol Aqua 30 | 87 |

This example shows the high uptake of sulfentrazone in aggregates produced using different polymers, whether crosslinked or uncrosslinked.

### Example 10

### Preparation of Aggregates of Atlox Metasperse 550S, Sulfentrazone, and Various Surfactants

Aggregates of sulfentrazone were prepared using Atlox Metasperse 550S and various Ethoquad surfactants. A series of Ethoquad surfactants of various chemical structures (Akzo Nobel) were used. Ethoquad surfactants are commercially available bis-ethoxylated quaternary ammonium salts with monomethylalkyl radical varying in chain length and counterions (Table 5). The sulfentrazone concentration in the mixtures was kept constant and was 0.5%. Atlox Metasperse 550S concentration was 0.15% in all cases. The concentration of corresponding surfactant in the mixture was varied to obtain aggregates with maximal uptake of sulfentrazone. The aggregates were obtained and separated following the procedure described in Example 2. The concentrations of sulfentrazone in the supernatants were determined using UV-spectroscopy. The calculated values of sulfentrazone uptake in the aggregates prepared are summarized in Table 5.

TABLE 5

| | | | Uptake of |
|---|---|---|---|
| | | | sulfentrazone in |
| | | | the aggregate |
| | Surfactant | Description | (w/w %) |
| 10A | Ethoquad | Cocoalkylmethyl[ethoxylated | 84 |
| | C/12 | (2)]-ammonium nitrate | |
| | Nitrate | | |
| 10B | Ethoquad | Cocoalkylmethyl[ethoxylated | 84 |
| | C/12-75 | (2)]-ammonium chloride | |
| 10C | Ethoquad | Tris(2-hydroxyethyl)tallowalkyl | 75 |
| | T/13-27W | ammonium acetate | |
| 10D | Ethoquad | Oleylmethyl[ethoxylated (2)]- | 82 |
| | O/12 PG | ammonium chloride | |

The data shows that the amount of sulfentrazone uptake also varies with the identity of the surfactant used.

### Example 11

### Preparation of Aggregates of Sokalan PA-15 Sulfentrazone, and Various Surfactants

Aggregates of sulfentrazone were prepared using Sokalan PA-15, linear polyacrylic acid sodium salt with low molecular weight of 1200 g/mol, and various Arquad surfactants. A series of Arquad surfactants of various chemical structures (Akzo Nobel) were used. Arquad surfactants are commercially available alkyltrimethyl quaternary ammonium chlorides varying in alkyl chain length (Table 6). The sulfentrazone concentration in the mixtures was kept constant and was 0.5%. Sokalan concentration was 0.2% in all cases. The concentration of corresponding surfactant in the mixture was varied to obtain aggregates with maximal uptake of sulfentrazone. The aggregates were obtained and separated following the procedure described in Example 2. The concentrations of sulfentrazone in the supernatants were determined using UV-spectroscopy. The calculated values of sulfentrazone uptake in the aggregates prepared are summarized in the Table 6.

TABLE 6

| | | | Uptake of |
|---|---|---|---|
| | | | sulfentrazone in |
| | Surfactant | Description | the aggregate (w/w %) |
| 11A | Arquad 12- | Dodecyltrimethyl ammonium chloride | 91 |
| | 37W | (aqueous solution) | |
| 11B | Arquad 12-50 | Dodecyltrimethyl ammonium chloride | 95 |
| | | (aqueous isopropanol solution) | |
| 11C | Arquad 16-50 | Hexadecyltrimethyl ammonium | 94.7 |
| | | chloride (aqueous isopropanol solution) | |
| 11D | Arquad 18-50 | Octadecyltrimethyl ammonium | 95.2 |
| | | chloride (aqueous isopropanol solution) | |
| 11E | Arquad C-50 | Cocoalkyltrimethyl ammonium | 94.7 |
| | | chloride | |
| | | (aqueous isopropanol solution) | |
| 11F | Arquad T-27W | Tallowalkyltrimethyl ammonium | 95 |
| | | chloride | |
| | | (aqueous solution) | |
| 11G | Arquad T-50 | Tallowalkyltrimethyl ammonium | 92.5 |
| | | chloride | |
| | | (aqueous isopropanol solution) | |

This set of examples shows that the solvents present and the length of the hydrophobic groups of the surfactant affects the sulfentrazone uptake in the aggregate made with uncrosslinked linear polymers. Longer hydrophobic groups allow for greater sulfentrazone uptake.

### Example 12

### Preparation of Aggregates of Carbopol Aqua 30, Sulfentrazone, and Various Surfactants

Aggregates of sulfentrazone were prepared using Carbopol Aqua 30, a dispersion of swollen particles of cross-linked polyacrylic acid, and various Arquad surfactants (Table 7). The sulfentrazone concentration in the mixtures was kept constant and was 0.5%. Carbopol Aqua 30 concentration was 0.2% in all cases. The concentration of corresponding surfactant in the mixture was varied to obtain aggregates with maximal uptake of sulfentrazone. The aggregates were obtained in the form orf precipitates and separated following the procedure described in Example 2. The concentrations of sulfentrazone in the supernatants were determined using UV-spectroscopy. The calculated values of sulfentrazone uptake in the aggregates prepared are summarized in the Table 7.

TABLE 7

| | | | Uptake of |
|---|---|---|---|
| | | | sulfentrazone in |
| | Surfactant | Description | the aggregate (w/w %) |
| 12A | Arquad 12- | Dodecyltrimethyl ammonium chloride | 75.7 |
| | 37W | (aqueous solution) | |
| 12B | Arquad 12-50 | Dodecyltrimethyl ammonium chloride | 86.6 |
| | | (aqueous isopropanol solution) | |
| 12C | Arquad 16-50 | Hexadecyltrimethyl ammonium chloride | 80.4 |
| | | (aqueous isopropanol solution) | |
| 12D | Arquad 18-50 | Octadecyltrimethyl ammonium chloride | 89 |
| | | (aqueous isopropanol solution) | |
| 12E | Arquad C-50 | Cocoalkyltrimethyl ammonium chloride | 85.3 |
| | | (aqueous isopropanol solution) | |
| 12F | Arquad T-27W | Tallowalkyltrimethyl ammonium | 84.6 |
| | | chloride | |
| | | (aqueous solution) | |
| 12G | Arquad T-50 | Tallowalkyltrimethyl ammonium | 83.7 |
| | | chloride | |
| | | (aqueous isopropanol solution) | |

This set of examples shows that the solvents present and the length of the hydrophobic groups of the surfactant affects the sulfentrazone uptake in the aggregates made with crosslinked polymers. Shorter hydrophobic groups allow for greater sulfentrazone uptake, and mixed solvents result in greater sulfentrazone uptake.

### Laboratory Release Studies

### Example 13

### Release of the Herbicide from the Atlox Polymer/Surfactant Aggregates

Release of sulfentrazone from polymer/surfactant aggregates into media with different composition and pH values was detected for a period of time up to 6 days on a daily basis. The aggregates were obtained using Atlox Metasperse 550S polymer and tetradecyltrimethylammonium bromide (C14NBr) mixtures and separated following the procedure described in Example 2. The concentrations of reagents in weight % in the mixtures were 0.4% of Atlox 550S, 1% of sulfentrazone, and 1.5% of C14NBr, respectively. The uptake of sulfentrazone into Atlox 550S/C14NBr aggregates was calculated to be 90%. Release studies were initiated by replacing the supernatants with 1.5 ml of washing liquid. The following aqueous solutions were used as washing liquids: tap water; 0.01 M Tris/HCl buffer, pH=7.0; and 0.01 M Tris/HCl buffer, pH=9.0.

The samples were shaken for 24 hours, the supernatants were separated from precipitate by ultracentrifugation and the concentration of sulfentrazone was determined using UV-spectroscopy. Then the procedure of washing was repeated again. The release of sulfentrazone from the aggregates was calculated using the absorbance data according the equation (3):

$$Release = \frac{{C ( SFT )}_{wash}}{{C ( SFT )}_{complex}} * 100 \% , \qquad ( 3 )$$

where C(SFT)_{wash} is the concentration of sulfentrazone in the washing liquid and C(SFT)_{complex} is the concentration of sulfentrazone initially incorporated into the aggregate. The calculated values of sulfentrazone released from the Atlox 550S/C14NBr aggregates are summarized in the Table 8.

TABLE 8

| | Sulfentrazone release (%) | | | | | | Total |
|---|---|---|---|---|---|---|---|
| Washing liquid | 1 day | 2 day | 3 day | 4 day | 5 day | 6 day | release, % |
| Tap water, pH | 20.1 | 7.2 | 4.9 | 5.7 | 5.0 | 5.1 | 48.8 |
| about 6.0 | | | | | | | |
| Tris/HCl buffer, | 19.2 | 8.1 | 5.7 | 7.1 | 4.2 | 5.4 | 49.7 |
| pH = 7.0 | | | | | | | |
| Tris/HCl buffer, | 11.1 | 7.9 | 4.0 | 7.9 | 4.7 | 5.6 | 41.2 |
| pH = 9.0 | | | | | | | |

This example shows the controlled release of charged pesticide from the aggregates as well as the effect of pH on the release, where release is lower at higher pH. This contrasts with the solubility of free sulfentrazone which sharply increases as the pH increases from 7 to 9.

### Example 14

### Release of the Herbicide from the REAX 88BPolymer/Surfactant Aggregates

Release of sulfentrazone from a REAX 88B/tetradecyltrimethylammonium bromide (C14NBr) aggregate into media with different composition and pH values was detected for a period of time up to 7 days on a daily basis. The sulfentrazone/REAX 88B/C14NBr aggregate, 8C, was obtained and separated following the procedure described in Example 8. Release studies were initiated by replacing the supernatants with 1.5 mL of washing liquid. Tap water and 0.01 M Tris/HCl buffer, pH=9.0, were used as washing liquids.

The samples were shaken for 24 hours, the supernatants were separated from precipitate by ultracentrifugation and the concentration of sulfentrazone was determined using UV-spectroscopy. Then the procedure of washing was repeated again. The release of sulfentrazone from the aggregate was calculated using the absorbance data as described in Example 13 and calculated values are summarized in the Table 9

TABLE 9

| | | | | | | | | Total |
|---|---|---|---|---|---|---|---|---|
| Washing | Sulfentrazone release (%) | | | | | | | release, |
| liquid | 1 day | 2 day | 3 day | 4 day | 5 day | 6 day | 7 day | % |
| Tap water, | 26.8 | 12.7 | 4.1 | 3.1 | 1.11 | 1.7 | 1.1 | 50.6 |
| pH of about | | | | | | | | |
| 6.0 | | | | | | | | |
| Tris/HCl | 14.4 | 19.7 | 5.0 | 2.2 | 0.6 | 1.3 | 1.7 | 45.0 |
| buffer, | | | | | | | | |
| pH = 9.0 | | | | | | | | |

This example again shows the controlled release of charged pesticide from the aggregate as well as the effect of pH on the release. As with the above example, release is lower at higher pH.

### Example 15

### Release of Sulfentrazone from the Sokalan Polymer/Surfactant Aggregates

Aggregates of sulfentrazone were prepared using linear polyacrylic acid sodium salt (Sokalan PA series from BASF) and tetradecyltrimethylammonium bromide (C14NBr) mixtures as described in Example 6. Release of sulfentrazone from the aggregates into tap water was detected for a period of time up to 6 days on a daily basis. Release studies were initiated by replacing the supernatants with 1.5 ml of tap water. The samples were shaken for 24 hours; the supernatants were separated from precipitates by ultracentrifugation. Concentration of sulfentrazone in the supernatants was determined using UV-spectroscopy. Then the procedure of washing was repeated again. The release of sulfentrazone from the aggregates was calculated using the absorbance data as described in Example 13 and calculated values are summarized in the Table 10.

TABLE 10

| | Sulfentrazone release (%) | | | | | | Total |
|---|---|---|---|---|---|---|---|
| Complex | 1 day | 2 day | 3 day | 4 day | 5 day | 6 day | release, % |
| 6A | 4.2 | 3.2 | 3.4 | 3.1 | 3.1 | 2.6 | 19.6 |
| 6B | 12.8 | 3.5 | 2.3 | 2.3 | 2.2 | 3.2 | 26.3 |
| 6C | 11.8 | 3.4 | 3.0 | 2.7 | 2.3 | 2.1 | 25.3 |
| 6D | 10.6 | 2.2 | 2.6 | 2.5 | 2.8 | 20. | 22.7 |
| 6E | 19.1 | 7.8 | 2.0 | 1.5 | 1.5 | 1.3 | 33.0 |

This data shows that the total release of charged pesticide generally increases with increasing molecular weight of the polymer.

### Example 16

### Release of Sulfentrazone from Carbopol Aqua 30/Surfactant Aggregate

Release of sulfentrazone from a sulfentrazone/Carbopol Aqua 30/tetradecyltrimethylammonium bromide (C14NBr) aggregate into tap water was detected on a daily basis for a period of time up to 6 days. Release studies were initiated by adding 1.5 mL of tap water to precipitate followed by shaking for 24 hours. The supernatants were separated from precipitates by ultracentrifugation. Concentration of sulfentrazone in the supernatants was determined using UV-spectroscopy. Then the procedure of washing was repeated again. The release of sulfentrazone from the aggregate was calculated using the absorbance data as described in Example 13 and calculated values are summarized in the Table 11.

TABLE 11

| | Sulfentrazone release (%) | | | | | | Total |
|---|---|---|---|---|---|---|---|
| Washing liquid | 1 day | 2 day | 3 day | 4 day | 5 day | 6 day | release, % |
| Tap water | 8.2 | 7.3 | 3.8 | 3.4 | 3.3 | 3.3 | 29.4 |

This example shows the release of charged pesticide from the aggregate where the polymer employed is crosslinked.

### Example 17

### Release of Sulfentrazone from Various Polymer/Surfactant Aggregates

Aggregates of sulfentrazone were prepared using Ethoquad O/12 PG (oleylmethyl[ethoxylated (2)]-ammonium chloride, Akzo) as a surfactant and various carboxylate-containing polymers (Table 12). The concentrations of the components in the reaction mixtures was kept constant in all cases and were 1% for sulfentrazone, 0.4% for polymer, and 1.7% for Ethoquad O/12 PG, respectively. Release of sulfentrazone from the aggregates into tap water and in Tris/HCl buffer, pH 9.0 was measured for a period of time up to 5 days on a daily basis. Release studies were initiated by replacing the supernatants with 1.5 ml of washing liquid. The samples were shaken for 24 hours; the supernatants were separated from precipitates by ultracentrifugation. Concentration of sulfentrazone in the supernatants was determined using UV-spectroscopy. Then the procedure of washing was repeated again. The release of sulfentrazone from the aggregates was calculated using the absorbance data as described in Example 13 and calculated values are summarized in the Tables 12A and 12B.

TABLE 12A
Release of sulfentrazone into Tap Water

| | | | | | | | Total |
|---|---|---|---|---|---|---|---|
| | | Sulfentrazone release (%) | | | | | release, |
| Complex | Polymer | 1 day | 2 day | 3 day | 4 day | 5 day | % |
| 17A | Sokalan PA-15 | 10.4 | 5.2 | 3.9 | 3.7 | 3.8 | 26.9 |
| 17B | Sokalan PA 30 | 22.9 | 5.2 | 4.7 | 3.5 | 3.2 | 40.0 |
| | CLPN | | | | | | |
| 17C | Carbopol | 11.3 | 4.5 | 3.2 | 4.6 | 4.8 | 28.4 |
| | Aqua 30 | | | | | | |

TABLE 12B
Release of Sulfentrazone into Tris/HCl Buffer, pH 9.0

| | Sulfentrazone release (%) | | | | | |
|---|---|---|---|---|---|---|
| Complex | 1 day | 2 day | 3 day | 4 day | 5 day | Total release, % |
| 17A | 17.3 | 5.8 | 2.4 | 4.2 | 2.0 | 31.7 |
| 17B | 29.7 | 10.2 | 3.2 | 2.5 | 3.3 | 48.8 |
| 17C | 11.7 | 4.4 | 3.3 | 3.1 | 3.8 | 26.2 |

This data shows the total release of sulfentrazone from ternary aggregates with Sokalan polymer.

### Example 18

### Release of the Sulfentrazone from the Polymer/Various Surfactant Aggregates

Aggregates of sulfentrazone were prepared using Sokalan PA-15, linear polyacrylic acid sodium salt with low molecular weight of 1200 g/mol, and various Arquad surfactants as described in Example 11. Release of sulfentrazone from such aggregates into tap water was measured for a period of time up to 6 days on a daily basis. Release studies were initiated by replacing the supernatants with 1.5 mL of water. The samples were shaken for 24 hours. The supernatants were separated from precipitates by ultracentrifugation. Concentration of sulfentrazone in the supernatants was determined using UV-spectroscopy. Then the procedure of washing was repeated again. The release of sulfentrazone from the aggregate was calculated using the absorbance data as described in Example 13 and calculated values are summarized in the Table 13.

TABLE 13

| | Sulfentrazone release (%) | | | | | | Total |
|---|---|---|---|---|---|---|---|
| Complex | 1 day | 2 day | 3 day | 4 day | 5 day | 6 day | release, % |
| 11A | 2.3 | 2.2 | 2.6 | 3 | 3.2 | 3.6 | 16.9 |
| 11B | 1.9 | 2.2 | 1.3 | 2.9 | 3.2 | 3.8 | 15.3 |
| 11C | 0.7 | 1.7 | 1 | 0.7 | 0.9 | 0.3 | 5.3 |
| 11D | 1.1 | 0.8 | 0.6 | 0.7 | 0.9 | 0.4 | 4.5 |
| 11E | 1.7 | 1.7 | 1.1 | 2.3 | 2.6 | 2.1 | 11.5 |
| 11F | 0.7 | 0.8 | 0.4 | 0.6 | 0.6 | 0.4 | 3.5 |
| 11G | 1 | 0.65 | 0.6 | 0.9 | 1 | 0.6 | 4.8 |

This data shows lower release when surfactants having longer hydrophobic chains are employed.

### Example 19

### Release of Sulfentrazone from Various Polymer/Surfactant Aggregates

Aggregates of sulfentrazone were prepared using Sokalan PA-15, linear polyacrylic acid sodium salt with low molecular weight of 1200 g/mol, and various Arquad surfactants as described in Example 11. Release of sulfentrazone from the aggregates into Tris/HCl buffer, pH 9.0 was measured for a period of time up to 5 days on a daily basis. Release studies were initiated by replacing the supernatants with 1.5 ml of washing liquid. The samples were shaken for 24 hours; the supernatants were separated from precipitates by ultracentrifugation. Concentration of sulfentrazone in the supernatants was determined using UV-spectroscopy. Then the procedure of washing was repeated again. The release of sulfentrazone from the aggregates was calculated using the absorbance data as described in Example 13 and calculated values are summarized in Table 14.

TABLE 14

| | Sulfentrazone release (%) | | | | | Total |
|---|---|---|---|---|---|---|
| Complex | 1 day | 2 day | 3 day | 4 day | 5 day | release, % |
| 10A | 3.1 | 3.9 | 4.6 | 5.2 | 5 | 21.8 |
| 10B | 2.1 | 2.5 | 5 | 4.7 | 4.7 | 19.0 |
| 10C | 0.6 | 2.5 | 3.5 | 1.5 | 0.2 | 8.3 |
| 10D | 2.8 | 0.9 | 0.7 | 0.6 | 0.1 | 5.1 |
| 10E | 2 | 0.4 | 3.5 | 4 | 3.2 | 13.1 |
| 10F | 0.6 | 1.2 | 0.6 | 1 | 0.28 | 3.7 |
| 10G | 1 | 2.4 | 0.7 | 0.5 | 0.1 | 4.7 |

This data when compared to the data of Example 18, shows that the release of sulfentrazone at higher pH is greater over time.

### Examples for Soil Column Application

The general protocol for evaluation of the soil mobility of the pesticidal aggregates of this invention through the use of soil columns is now described. Both dry soil columns and wet soil columns were used.

The procedure for dosing the dry soil column was as follows. To each well of the first three rows of a 24-well long tip polypropylene plate (Whatman, 24 well, 10 mL natural polypropylene filter plate with GF/C, Cat #7700-9901) was added 10 g of soil. No soil is added to the fourth row. The plate was lightly tapped on the sides to create minimal packing of the soil particles in each well. The dosing of each formulation was done in replicates of 4, three for the wells containing soil (the first three rows) and one for the soil-less well (fourth row). Each well (with or without soil) was dosed with an equal amount of the dosing formulation (solid or liquid solution). Each well was dosed with an amount of the formulation (solution or solid) that delivered about 500 μg of pesticide to the top of the soil column. The aliquot added to the soil is allowed to dry (assuming the dosing formulation was a liquid). If the dosing formulation was a solid then the elution process was initiated immediately. The packed and dosed 24 well filter plate (Whatman, 24 well, 10 mL natural polypropylene filter plate with GF/C, Cat #7700-9901) was placed on a collection plate (Whatman Uniplate, 24 well, 10 mL natural polypropylene round bottom collection plate, Cat #7701-5102). Distilled water was added to each well in 1.0 mL aliquots via a multi-channel pipettor while ensuring minimal disturbance of the soil on the top of each well. For the dry column, eluate did not accumulate in the 24 well collection plate until about 3-4 mL of water had been added to each column. Fractions were collected in 1.0 mL aliquots and analyzed by HPLC. The results were appropriately normalized and the rate at which the pesticide was eluted off the soil column was determined.

The procedure for dosing the wet soil column was as follows. To each well of the first three rows of the 24-well long tip polypropylene plate (Whatman, 24 well, 10 mL natural polypropylene filter plate with GF/C, Cat #7700-9901) was added 10 g of soil. No soil was added to the fourth row. The plate was lightly tapped on the sides to created minimal packing of the soil particles in each well. A collection plate (Whatman Uniplate, 24 well, 10 mL natural polypropylene round bottom collection plate, Cat #7701-5102) was placed under the soil packed filter plate. Distilled water (3-4 mL) was added slowly to each column to minimize the disturbance of the top of the soil column or until drops of water began to appear in the collection plate. The wet soil column was allowed to drain. The dosing procedure and the remainder of the protocol for the dry column were then followed.

HPLC conditions. The HPLC system was a Waters Alliance 2695. The column was a Phenomenex Prodigy 5μ ODS (2), 4.5 mm×150 mm. The flow rate was 1.0 mL/min. Solvent A was acetonitrile. Solvent B was water (0.025% TFA). The detector was a Waters 2996 Photodiode Array, quantitation at 230 nm. The gradient conditions are presented in Table 15.

TABLE 15
Gradient Conditions

| Time (Mins) | Flow | % B | % C |
|---|---|---|---|
| 0.00 | 1.0 | 20.0 | 80.0 |
| 4.50 | 1.0 | 95.0 | 5.0 |
| 6.00 | 1.0 | 95.0 | 5.0 |
| 6.10 | 1.0 | 20.0 | 80.0 |
| 9.00 | 1.0 | 20.0 | 80.0 |

### Example 20

### Preparation of Sulfentrazone Aggregates for Evaluation Using Dry Soil Columns

Sulfentrazone solution, concentration ranging from 0.5% to 5% in water, is weighed into a container of suitable size. To this is added polyacrylic acid or modified polyacrylic acids. These may be in the acid form or in the neutralized form. Extra NaOH is added to samples with the acid form polyacrylic acid to maintain an alkaline pH. The pH of the mixture at this stage is in the range of 10-12.4. Depending on the type of polyacrylic acid, the mixture at this stage may be a solution (linear polymers) or a translucent dispersion (cross linked polymers). Finally, a quaternary ammonium salt is added, either as supplied by the manufacturer or as an aqueous solution. The quaternary ammonium salt is preferably added while mixing. The aggregate forms as a white precipitate which may settle or may remain suspended as a viscous opaque dispersion. The container with the aggregate mixture is then homogenized using a laboratory high speed mixer (Ultra-Turrax T-25) at low speed. Tergitol XD (emulsifier, block copolymer of ethylene oxide/propylene oxide) is then added and the speed of the homogenizer is increased and maintained for approximately 1 minute. The products of this procedure are translucent fluid dispersions. Amounts of various components which have been used to make aggregates according to this Example are listed in Table 16.

TABLE 16
Table of Quantities of components used as Examples

| Reference | 20-1 | 20-2 | 20-3 | 20-4 | 20-5 | 20-6 |
|---|---|---|---|---|---|---|
| Sulfentrazone 2.5% w/w | 6.58 | 6.58 | 6.58 | 13.1 | 26.3 | 5.93 |
| solution in water, pH 12.4 | | | | | | |
| NaOH 10% w/w solution | 0.234 | 0.234 | 0.234 | 0.468 | 0 | 0 |
| Carbopol Aqua 30 | 0.146 | 0.146 | 0.146 | 0 | 0 | 0 |
| Carbopol EZ-4 | 0 | 0 | 0 | 0.092 | 0 | 0 |
| Metasperse 550S | 0 | 0 | 0 | 0 | 2.52 | 0 |
| Metasperse 100L | 0 | 0 | 0 | 0 | 0 | 0.41 |
| Arquad 12-37W | 0.27 | 0 | 0 | 0 | 0 | 0 |
| Arquad 16-29 | 0 | 0.355 | 0 | 0 | 0 | 0 |
| Arquad 18-50 | 0 | 0 | 0.239 | 0 | 0 | 0 |
| Tetradecyl trimethyl | 0 | 0 | 0 | 5.16 | 10.32 | 2.27 |
| ammonium bromide, | | | | | | |
| 10% soln | | | | | | |
| Water | 2.55 | 2.54 | 2.50 | 0 | 0 | 1.67 |
| Tergitol XD | 0.53 | 0.50 | 0.50 | 1.50 | 0 | 1.00 |

Part of the sample was further treated as follows. A portion of the mixture was dried at 50 degrees centigrade overnight to constant weight. The residue was a clear colorless film. 0.14 grams of the dry residue was dissolved in 1.886 grams of chloroform. The solution was clear and pale yellow in color, and assayed 3.1% sulfentrazone.

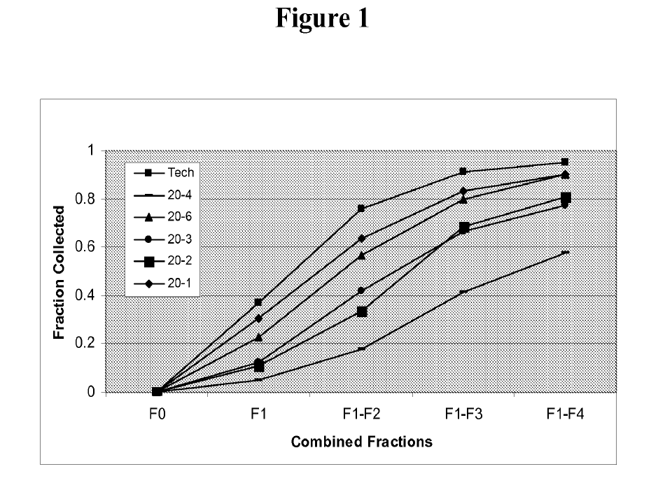

The dry soil column protocol was utilized to evaluate the mobility of sulfentrazone in the aggregates. The results of such testing are shown in FIG. 1. This data demonstrates that the elution of pesticide in soil may be controlled through the aggregates of the invention versus free sulfentrazone.

### Example 21

### Preparation of Radiolabelled Sulfentrazone Aggregate Formulations, Using Sodium Polyacrylate and Quaternary Amine

The following procedure is used to evaluate different ratios of polyacrylic acid and quaternary ammonium chloride at a fixed (approx) loading of sulfentrazone in radio-labeled formulations for application to soil.

A Sulfentrazone 5% w/w active aqueous solution, pH 12.4 was prepared by combining 5.0 grams sulfentrazone technical, 94 grams deionized water and 6 grams of 10% w/w sodium hydroxide solution in a 200 mL bottle and stirred with while heating to 60 degrees C. When dissolved, the solution is cooled and deionized water is added to a total weight of 100 grams. Radiolabelled sulfentrazone solution in methanol is added into this solution at the required level such that the solution remained clear. A volume of Sokalan PA-15 (45.4% sodium polyacrylic as supplied, BASF) equivalent to 10 grams of polyacrylic acid was diluted to 100 grams with deionized water with vigorous stirring to dissolve or disperse the polyacid. The solution was clear to translucent, with no particulate materials visible.

Alkyl trimethyl ammonium chlorides (Arquads), available from AKZO (note that the C14 alkyl product is not a commercial product, but has been used as a standard relatively pure product, and Arquad C16/29 as a 29% solution of C16 alkyl trimethyl ammonium chloride) were used as supplied.

Sulfentrazone solution, the Sokalan PA-15 (sodium polyacrylate) solution, and water in a 20 mL glass vial were combined and mixed on a vortexer to form a clear solution. The quaternary amine solution was added slowly while stirring. A composition of the mixture is shown in Table 17. A precipitate started to form after about half the solution was added. Mixing was continued for a further 30 minutes to complete the precipitation. The vial was wrapped in a polyethylene bag to prevent leakage of radio label.

TABLE 17

| Quantities | gms | Eq Ratio |
|---|---|---|
| 5% sulfentrazone solution pH 11.4 | 3.75 | 0.81 |
| Sokalan PA-15 (as supplied 45.4%) | 0.125 | 1.00 |
| Water | 6.83 | |
| Arquad 16/29 (as supplied 29%) | 1.00 | 1.21 |

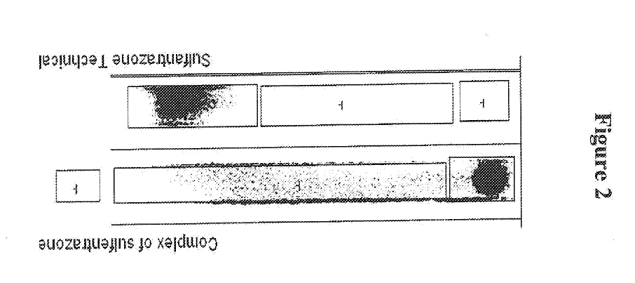

FIG. 2 depicts the release of free sulfentrazone from the aggregate. FIG. 2 demonstrates the movement of radio-labelled sulfentrazone aggregate on a TLC plate using soil as the medium after elution with water (left hand column), compared with a standard sulfentrazone technical solution (right hand column). The concentrations of sulfentrazone are indicated by the depth of the shading in the radio trace. The right hand channel shows that technical sulfentrazone has moved from the point of application to form a band near the far end of the channel. There is virually no sulfentrazone in the intermediate region. The left hand channel shows that part of the sulfentrazone in the aggregate has hardly moved at all, but significant amounts are distributed along the whole length of the soil channel. These data indicate that sulfentrazone in the aggregated form shows less soil movement and distributes in soil to minimize leaching and to provide effective concentrations in the growing root area.

### Preparation and Analysis of Other Compositions According to the Invention

### Example 22

### Preparation of Aggregates of Geropone, Sulfentrazone, and Various Surfactants

Aggregates of sulfentrazone were prepared using Geropone EGPM, a maleic acid-containing polymer (Rhodia), and various Arquad surfactants. The sulfentrazone concentration in the mixtures was kept constant and was 0.5%. Geropone concentration was 1.5% in all cases. The concentration of corresponding surfactant in the mixture was 2.2%. The formation of white flakes of non-sticky precipitates was observed in all cases. The aggregates were separated following the procedure described in Example 2. The concentrations of sulfentrazone in the supernatants were determined using UV-spectroscopy. The calculated values of sulfentrazone uptake in the aggregates prepared are summarized in the Table 18.

TABLE 18

| | | Uptake of sulfentrazone in the | |
|---|---|---|---|
| | Surfactant | aggregate (w/w %) | Loading, L (%) |
| 22A | Arquad 12-50 | 75 | 10 |
| 22B | Arquad 16-50 | 93 | 12.5 |
| 22C | Arquad 18-50 | 93 | 12 |
| 22D | Arquad T-50 | 92 | 12 |

This data shows that the uptake and load of sulfentrazone in the aggregates increases with increasing length of the hydrophobic groups of the surfactant.

### Example 23

### Release of Sulfentrazone from the Geropone/Arquad Aggregates

Aggregates of sulfentrazone were prepared using Geropone EGPM, a maleic acid-containing polymer (Rhodia), and various Arquad surfactants as described in Example 22. Release of sulfentrazone from aggregates into tap water or into Tris/HCl buffer, pH 9.0 was measured for a period of time up to 5 days on a daily basis following the procedure described in Example 17. The calculated values of the sulfentrazone released are summarized in the Table 19.

TABLE 19

| | Sulfentrazone release (%) | | | | | |
|---|---|---|---|---|---|---|
| Complex | 1 day | 2 day | 3 day | 4 day | 5 day | Total release, % |
| | Tap water, pH about 6.0 | | | | | |
| 22B | 2 | 6 | 14 | 5 | 2 | 29 |
| 22D | 3 | 2 | 2 | 2 | 2 | 11 |
| | TRIS buffer, pH 9.0 | | | | | |
| 22B | 2 | 20 | 23 | 14 | 4 | 63 |
| 22D | 2 | 3 | 20 | 16 | 4 | 45 |

This data shows that the release of sulfentrazone is controlled and that the total release is greater at higher pH.

### Preparation of Aggregates Employing Oppositely Charged Pesticide and Polymers

### Example 24

### Preparation of an Aggregate of Sulfentrazone, Poly(N,N-diallyl-N,N-dimethylammonium chloride) and Sodium Dodecylsulfate

An aggregate of sulfentrazone were prepared using cationic polyelectrolyte-poly(N,N-diallyl-N,N-dimethylammonium chloride) (PDADMAC) and anionic surfactant—sodium dodecylsulfate (SDS). 0.32 mL of sulfentrazone solution (1.3%, pH 11.7) were mixed with 0.456 mL of SDS aqueous solution (5.76%), kept for 1 day and then added to 1 mL of PDADMAC solution. (0.67%) upon stirring. An aggregate was formed and was separated following the procedure described in Example 2. The concentration of sulfentrazone in the supernatant was determined using UV-spectroscopy. The calculated values of sulfentrazone uptake and loading in the aggregate were 8% and 3.5%, respectively.

### Example 25

### Preparation of an Aggregate of sulfentrazone, Polyquartermium 7 and Stepwet DF-90

A 10% solution of sulfentrazone was prepared by dissolving sulfentrazone in 1 equivalent of sodium hydroxide solution and stirring overnight. 3.87 grams of sulfentrazone in such a solution was placed into a 20 mL glass vial and 7.24 grams (1 equivalent) of a 10% solution of Polyquarternium 7 poly[(N,N-dimethyl-N-2-propenyl-2-propen-1-aminium chloride)] was added. The mixture was stirred at room temperature using a vortex mixer. 2.06 grams (2 equivalents) of Stepwet DF-90 (sodium alkylbenzene sulfonate) was added and the mixture was stirred using a vortex mixer. Mixing of the anionic surfactant with the catioinic polymer and the anionic pesticide resulted in the formation of a precipitate. Employing the method described in Example 2, it was calculated that the aggregate contained only a minimal amount of pesticide.

### Example 26

### Preparation of an Aggregate of sulfentrazone, Polyquartermium 7 and Agnique PE TDA-6

The process above for Example 25 was repeated except that 5.65 grams (2 equivalents) of Agnique PE TDA-6 (phosphate ester of tristyrylphenol) was employed in place of the Stepwet DF-90. Mixing of the anionic surfactant with the catioinic polymer and the anionic pesticide resulted in the formation of a precipitate. Employing the method described in Example 2, it was calculated that the aggregate contained only a minimal amount of pesticide.

The results of Examples 24-26 show that although aggregates can be formed employing polymers having a charge opposite to that of the pesticide, such embodiments are less preferred as less pesticide gets taken up into the aggregate than in aggregates produced from oppositely charged polymers and pesticides.

### Example 27

### Preparation of Aggregates Employing a Cationic Polymer and an Anioinc Surfactant

A 10% solution of paraquat, a positively charged pesticide, was prepared by diluting Gramoxone Max with distilled water. 1.29 grams of paraquat (1 equivalent) was placed into a 20 mL glass vial. One equivalent of a 10% sodium hydroxide solution was added along with 3.62 grams (1 equivalent) of Polyquarternium 7 poly[(N,N-dimethyl-N2-propenyl-2-propen-1-aminium chloride)]. The mixture was stirred at room temperature using a vortex mixer. 4.12 grams (2 equivalents) of a 10% solution of Stepwet DF-90 (sodium alkylbenzene sulfonate) were added and the mixture was stirred. A precipitate was formed. Employing the method described in Example 2, it was calculated that 47% of the pesticide was included in the resulting aggregate.

Example 27 demonstrates that aggregates can be created employing cationic pesticides.

### Example 28

### Preparation of Aggregates Containing Other Pesticides

100 grams of the active ingredient listed was placed into a 20 mL vial and 1 equivalent of a 1 molar sodium hydroxide solution added. The mixture was stirred until the active dissolved (0.5 or 1.0 gram of deionized water was added if necessary). One equivalent of Sokalan PA-15 (linear polyacrylic acid sodium salt with low molecular weight of 1200 g/mol) was added and the mixture mixed. 2 equivalents of Arquad 18/50 octadecyltrimethyl ammonium chloride (aqueous isopropanol solution) were added and the mixture was stirred using a vortex mixer. Using a process similar to that described in Example 2, the amount of pesticide incorporated into the aggregate was measured. The results of such testing are summarized in Table 20.

TABLE 20

| Compound Name | pKa | Percent a.i. |
|---|---|---|
| Fenhexamid | 7.2 | 4.47 |
| 2,4-D | 2.9 | 2.45 |
| Bromoxynil | 5 | 4.34 |
| Clopyralid (Lontrel) | 3.2 | 3.46 |
| Cloransulam-methyl | 5.4 | 5.11 |
| Dicamba | 3 | 3.77 |
| Fomesafen | 4 | 7.17 |
| Glyphosate | 4.4 | 4.70 |
| Imazethapyr | 3 | 5.57 |
| Mesotrione | 3 | 6.21 |
| Nicosulfuron | 4.5 | 6.96 |
| Quizalofop-P | >3 | 4.76 |
| Lufenuron | 6.6 | 8.16 |
| Gibberellic acid | 4 | 6.28 |

The above results show that a wide range of charged pesticides can be incorporated into the aggregates of this invention.

### Example 29

### Preparation of Aggregates of Ethacryl M, Bifenthrin, and Arquad Surfactant

Aggregates of bifenthrin, a pesticide that is not charged and is characterized by octanol/water partition coefficient of log P>6, were prepared using Ethacryl M, a sodium salt of polyacrylic copolymer of comb-branched structure with polyol pendant groups (Lyondell), and octadecyltrimethyl ammonium chloride (Arquad 18-50, Akzo Nobel) surfactant mixtures. 0.224 mL of 4% solution of Arquad 18-50 solution in ethanol were mixed with 0.14 mL of Ethacryl M solution in ethanol (4%) and 0.005 mL of aqueous solution of NaOH (4%). Various amounts of 0.5% solution of bifenthrin in ethanol were added to the mixtures as outlined in Table 21. The mixtures were thoroughly mixed followed by evaporation of ethanol until white powder-like residues were left in the vials. Each of solid compositions was rehydrated in 2.5 mL of water upon stirring and opalescent dispersions were formed in all cases. The content of bifenthrin in the dispersions was determined by UV-spectroscopy using the equation of the calibration curve of bifenthrin (Abs=0.0125+4.3694 C_{bifenthrin}, r²=0.999). Standard solutions containing 0-0.58 mg/ml of bifenthrin in ethanol were used to obtain a calibration curve by measuring an absorbance at 260 nm using Perkin-Elmer Lambda 25 spectrophotometer. All bifenthrin was incorporated into the dispersions upon formation. The size of the complex particles loaded with bifenthrin was ca. 1 micron as determined by dynamic light scattering using “ZetaPlus” Zeta Potential Analyzer (Brookhaven Instrument Co.). The dispersion containing 0.4 mg/mL of bifenthrin was stable at least 24 hours followed by the formation of fine crystals of bifenthrin. The dispersion with BF concentration of 0.2 mg/mL< was stable for 2 days while the dispersion with bifenthrin content of 0.12 mg/mL was stable for at least 3 days without visible precipitation of the bifenthrin.

TABLE 21

| | Concentration of components | | | | |
|---|---|---|---|---|---|
| | in the dispersions, mg/mL | | | | |
| | | | Arquad | | Dispersion |
| | Ethacryl M | NaOH | 18-50 | Bifenthrin | stability (hours) |
| 33A | 2.24 | 0.08 | 4.48 | 0.12 | 72 |
| 33B | 2.24 | 0.08 | 4.48 | 0.2 | 48 |
| 33C | 2.24 | 0.08 | 4.48 | 0.4 | 24 |

This data shows the preparation of the aggregates with a hydrophobic pesticide.

### Comparative Experiment E

### Bifenthrin Plus Ethacryl M without the Presence of Surfactant

Bifenthrin, a pesticide that is not charged and is characterized by octanol/water partition coefficient of log P>6, was mixed with Ethacryl M, a sodium salt of polyacrylic copolymer of comb-branched structure with polyol pendant groups (Lyondell) without the presence of surfactant. 0.06 ml of 0.5% solution of bifenthrin in ethanol were mixed with 0.14 ml of Ethacryl M solution in ethanol (4%) and 0.005 ml of aqueous solution of NaOH (4%) followed by evaporation of ethanol until white powder-like residues were left in the vial. A solid composition was rehydrated in 2.5 ml of water upon stirring. A clear solution with no aggregate but with fine crystals of bifenthrin was formed. The resulting mixture was centrifuged at 15,000 g for 5 min and aqueous supernatant was separated. The content of bifenthrin in the supernatant was determined by UV-spectroscopy using the equation of the calibration curve of bifenthrin (Abs=0.0125+4.3694 C_{bifenthrin}, r²=0.999). Standard solutions containing 0-0.58 mg/ml of bifenthrin in ethanol were used to obtain a calibration curve by measuring an absorbance at 260 nm using Perkin-Elmer Lambda 25 spectrophotometer. No bifenthrin was detected in the solution.

### Example 30

### Preparation of Aggregates of Ethacryl M, Sulfentrazone, and Arquad Surfactant

Aggregates of sulfentrazone were prepared using Ethacryl M, a sodium salt of polyacrylic copolymer of comb-branched structure with polyol pendant groups (Lyondell), and octadecyltrimethyl ammonium chloride (Arquad 18-50, Akzo Nobel) surfactant mixtures. 0.125 mL of sulfentrazone solution (2%, pH 11.6) were mixed with 0.176 mL of Ethacryl M solution (4%) and 0.149 mL of water. No aggregate formation was observed. 0.05 mL of Arquad 18-50 solution (10%) was added to the mixture prepared upon stirring and immediate formation of opalescent dispersion was observed. An aliquot of the complex dispersion were centrifuged (10 min at 10,000 g) using Microcon centrifugal filter devices YM-10 (membrane with nominal molecular weight limit (NMWL) of 10,000 daltons) and concentration of sulfentrazone in the clear filtrate, which is not bound to the complex, was determined by UV-spectroscopy using a molar extinction coefficient of 16750 mol⁻¹cm⁻¹ L for sulfentrazone at λ=261 nm. For UV measurements both control and blank solutions were diluted to concentration of sulfentrazone of 0.002%, w/w, and their absorbance UV-spectra were recorded. The uptake of sulfentrazone into the complex was calculated using the absorbance data according the equation (4):

$$Uptake = \frac{{C ( SFT )}_{init} - {C ( SFT )}_{filt}}{{C ( SFT )}_{init}} * 100 \% , \qquad ( 4 )$$

as the difference between the initial concentration of sulfentrazone added (C(SFT)ᵢₙᵢₜ) and the final concentration of sulfentrazone in the filtrate (C(SFT)_{filt}), and expressed as a percentage of the initial concentration. Sulfentrazone uptake from solution was determined to be about 95%. The size of the particles of the aggregate in the dispersion was ca. 250 nm as determined by dynamic light scattering using “ZetaPlus” Zeta Potential Analyzer (Brookhaven Instrument Co.). No visible precipitation was observed in the dispersion for at least 3 days.

### Example 31

### Preparation of Aggregates of Ethacryl M, Dicamba, and Arquad Surfactant

Aggregates of Dicamba, 3,6-dichloro-o-anisic acid, dimethylamine salt, were prepared using Ethacryl M, a sodium salt of polyacrylic copolymer of comb-branched structure with polyol pendant groups (Lyondell), and Arquads surfactant mixtures. 0.075 mL of Dicamba solution (10%) were mixed with 0.184 mL of Ethacryl M solution (4%) and 0.149 mL of water. No aggregate formation was observed. The Dicamba concentration in the mixtures was kept constant and was 0.5%. Ethacryl M concentration was 0.5% in all cases. The concentration of corresponding surfactant in the mixture was varied to obtain the aggregates with maximal uptake of dicamba. Immediate formation of opalescent dispersions was observed after adding surfactant solutions to the polymer/Dicamba mixtures. An aliquot of the aggregate dispersion were centrifuged (10 min at 10,000 g) using Microcon centrifugal filter devices YM-10 (membrane with nominal molecular weight limit (NMWL) of 10,000 daltons) and concentration of Dicamba in the clear filtrate, which is not bound to the aggregate, was determined by UV-spectroscopy using an extinction coefficient of 1.84 mg⁻¹cm⁻¹ mL for Dicamba at λ=275 nm. For UV measurements both control and blank solutions were diluted to concentration of Dicamba of 0.05%, w/w, and their absorbance UV-spectra were recorded. The uptake of Dicamba into the aggregate was calculated using the absorbance data according the equation (5):

$$Uptake = \frac{{C ( DC )}_{init} - {C ( D C )}_{filt}}{{C ( D C )}_{init}} * 100 \% , \qquad ( 5 )$$

as the difference between the initial concentration of Dicamba added (C(DC)ᵢₙᵢₜ) and the final concentration of Dicamba in the filtrate (C(DC)_{filt}), and expressed as a percentage of the initial concentration. Dicamba uptake from solution was around 70% or lower. The size of the particles in the dispersion was ca. 560 nm as determined by dynamic light scattering using “ZetaPlus” Zeta Potential Analyzer (Brookhaven Instrument Co.). No visible precipitation was observed in the dispersion for at least 3 days.

TABLE 22

| | | Uptake of Dicamba in | Particle size |
|---|---|---|---|
| | Surfactant | the aggregate (w/w %) | (μm) |
| 31A | Arquad 12-37W, | 60 | 0.80 |
| | dodecyltrimethyl | | |
| | ammonium chloride | | |
| 31B | Arquad T-27W, | 69 | 0.56 |
| | tallowalkyltrimethyl | | |
| | ammonium chloride | | |

### Example 32

### Preparation of Aggregates of Ethacryl M, Pendimethalin, and Arquad Surfactant

Aggregates of pendimethalin, a herbicide that is not charged and is characterized by octanol/water partition coefficient of log P=5.2, were prepared using Ethacryl M, a sodium salt of polyacrylic copolymer of comb-branched structure with polyol pendant groups (Lyondell), and tallowalkyltrimethyl ammonium chloride (Arquad T-50, Akzo Nobel) surfactant mixtures. 0.032 mL of 5.1% solution of Arquad T-50 solution in ethanol were mixed with 0.2 mL of Ethacryl M solution in ethanol (4%), 0.005 mL of aqueous solution of NaOH (4%), and 0. L ml of 2% solution of pendimethalin solution in acetonitrile. The mixture was thoroughly mixed followed by evaporation of organic solvents until yellow powder-like residues were left in the vials. Solid composition was rehydrated in 2 mL of water upon stirring and opalescent dispersion was formed. The content of pendimethalin in the dispersion was determined by UV-VIS spectroscopy using the equation of the calibration curve of pendimethalin (Abs=−0.002+14.119 C_{pendimethalin}, r²=0.999). Standard solutions containing 0-0.06 mg/ml of pendimethalin in ethanol were used to obtain a calibration curve by measuring an absorbance at 428.8 nm using Perkin-Elmer Lambda 25 spectrophotometer. All pendimethalin was incorporated into the dispersions upon formation. The size of the complex particles loaded with pendimethalin was ca. 220 nm as determined by dynamic light scattering using “ZetaPlus” Zeta Potential Analyzer (Brookhaven Instrument Co.). The dispersion containing 2 mg/ml of pendimethalin was stable for at least 2 days without visible precipitation of pendimethalin.

### Example 33

### Preparation of Aggregate of Tebuconazole, Ethacryl M and Arquad T-50

8.0 grams of Ethacryl M were added to 12.0 grams of Arquad T-50 [tallowalkyltrimethyl ammonium chloride (aqueous isopropanol solution)] and the components mixed to form a clear solution. 2.0 grams of tebuconazole technical (95%) were added and the mixture was stirred magnetically at 35° C. for 2 hours, forming a clear pale yellow formulation. The formulation was easily dilutable in water at concentrations useful for agricultural application, typically 500-1000 ppm active, forming clear compositions ideal for spray application. 0.50 gram of the formulation was diluted in 50 mL of deionized water at 25° C. and a portion of the diluted composition was also held at 2° C. for 24 hours. Both formulations remained free of crystals. The diluted composition held at 25° C. remained free of crystals for longer than 3 days. The zeta potential of the formulation was measured to be +62.4 mV, demonstrating that the aggregate containing the tebuconazole is positively charged.

### Example 34

### Preparation of Aggregates of Tebuconazole, Ethacryl M and Arquad T-50

Employing a process identical to that of Example 34, several additional aggregates of Ethacryl M, Arquad T-50 and tebuconazole were formed, employing the amounts of ingredients set forth in Table 23 below.

TABLE 23

| | | | Tebuconazole |
|---|---|---|---|
| | | | Technical (95%) |
| Example | Ethacryl M (g) | Arquad T-50 (g) | (g) |
| 34A | 3 | 6 | 1 |
| 34B | 4 | 5 | 1 |
| 34C | 4.5 | 4.5 | 1 |
| 34D | 5 | 4 | 1 |
| 34E | 6 | 3 | 1 |

Formulations 34A-34D all appeared clear, whereas sediment was observed for formulation 34E. After dilution with 50 mL of deionized water, no crystallization was observed for formulations 34A-34D but crystals were observed for formulation 6E. These examples show that changing the polymer:surfactant ratio can affect the stability of this particular formulation.

### Example 35

### Preparation of Aggregates of Ethacryl M, Sokalan PA15, Sulfentrazone, and Arquads Surfactants

Aggregates of sulfentrazone were prepared using mixtures of Ethacryl M, a sodium salt of polyacrylic copolymer of comb-branched structure with polyol pendant groups (Lyondell), and Sokalan PA15, linear polyacrylic acid sodium salt with low molecular weight of 1200 g/mol. A series of Arquad surfactants of various chemical structures, (Akzo Nobel) were used as surfactant components of the aggregates (Table 24).

TABLE 24

| Surfactant | Description |
|---|---|
| Arquad T-50 | Tallowalkyltrimethyl ammonium chloride |
| | (aqueous isopropanol solution) |
| Arquad 2C-75 | Dicocoalkyldimethyl ammonium chloride |
| | (aqueous isopropanol solution) |
| Arquad HTL8-MS | Hydrogenated tallowalkyl(2-ethylhehyl)dimethyl |
| | ammonium sulfate (aqueous solution) |

Aggregates were prepared as described in Example 34. The molar ratio of polymers (Ethacryl M and Sokalan P15) in the mixtures was 1:2.3 (mol/mol). The mixtures were thoroughly mixed followed by evaporation of solvents until white powder-like residues were left in the vials. Each of solid compositions was rehydrated in water upon stirring to prepare the dispersions with final concentration of sulfentrazone of 1 mg/mL. Turbid dispersions were formed in all cases. The size of the particles in the dispersion was determined by dynamic light scattering using Saturn DigiSizer 5200 Analyzer (Micromeritics) and presented in Table 25. No visible precipitation was observed in the dispersion for at least 24 hours.

TABLE 25

| | | Particle |
|---|---|---|
| | Surfactant | size (μm) |
| 35A | Arquad T-50 | 24.9 |
| 35B | Arquad 2C-75 | 7.7 |
| 35C | Arquad HTL8-MS | 7.1 |
| 35D | Arquad t-50/Arquad HTL8-MS (1:1 mol/mol) | 5.7 |

### Example 36

### Preparation of Aggregates of Tebuconazole, Polymer Mixture and Arquad Surfactant

Aggregates of tebuconazole, a fungicide that is not charged and is characterized by octanol/water partition coefficient of log P=3.7, were prepared using mixtures of Ethacryl M, a sodium salt of polyacrylic copolymer of comb-branched structure with polyol pendant groups (Lyondell), and PPEM, ethoxylated anionic carboxylate-containing copolymer of comb-structure with pendant C₁₄-C₁₆ hydrophobic aliphatic groups (Akzo Nobel). Tallowalkyltrimethyl ammonium chloride, Arquad T-50, (Akzo Nobel) was used as a surfactant component of the aggregate. 0.04 mL of 12.8% solution of Arquad T-50 solution in ethanol were mixed with 0.14 mL of Ethacryl M solution in ethanol (4%), 0.074 mL of PPEM solution (10% in ethanol), 0.02 mL of aqueous solution of NaOH (4%), and 0.3 mL of 1% solution of tebuconazole in acetonitrile. The molar ratio of polymers, Ethacryl M and PPEM, in the mixtures was 2.3:1. The mixture was thoroughly stirred followed by evaporation of organic solvents until white wax-like residue was left in the vial. Solid composition was rehydrated in 1 mL of water upon stirring and turbid dispersion was formed. The content of tebuconazole in the dispersion was 3 mg/mL. The total concentration of polymer/surfactant components in the dispersion was ca. 1.8%. The aggregate loading capacity with respect to tebuconazole was 14 w/w %. The size of the aggregate particles loaded with tebuconazole was ca. 220 nm as determined by dynamic light scattering using “ZetaPlus” Zeta Potential Analyzer (Brookhaven Instrument Co.). The dispersion containing 3 mg/mL of tebuconazole was stable for at least 48 hours without visible precipitation of tebuconazole.

### Example 37

### Preparation of aggregates of poly(N-ethyl-4-vinylpyridinium bromide)-b-poly(ethylene oxide), tebuconazole, and anionic surfactant

Aggregates of tebuconazole, a fungicide that is not charged and is characterized by octanol/water partition coefficient of log P=3.7, were prepared using cationic polymer, poly(ethylene oxide)-block-poly(N-ethyl-4-vinylpyridinium bromide) (PEO-b-PEVP) and anionic surfactant—sodium dodecyl sulfate (SDS). The block lengths of PEO-b-PEVP were 110 for PEO and 200 for PEVP. 0.33 mL of 1% solution of PEO-b-PEVP solution in ethanol, 0.1 mL of SDS solution (1% in ethanol), and 0.3 mL of 1% solution of tebuconazole in acetonitrile were mixed together. The mixtures were thoroughly stirred followed by evaporation of organic solvents until white powder-like residues were left in the vials. Solid composition was rehydrated in 1 mL of water upon stirring and slightly opalescent dispersion was formed. The content of tebuconazole in the dispersion was 1 mg/mL. The total concentration of polymer/surfactant components in the dispersion was ca. 1.3%. The complex loading capacity with respect to tebuconazole was 7.4 w/w %. The dispersed aggregate particles loaded with tebuconazole were ca. 120 nm in diameter as determined by dynamic light scattering using “ZetaPlus” Zeta Potential Analyzer (Brookhaven Instrument Co.) The dispersions were stable for at least 24 hours without visible precipitation of the tebuconazole.

### Example 38

### Preparation of Aggregates of Sulfentrazone, Arquad 16/29 and Comb-Structured Polymers

Aggregates in the form of dispersions were produced by mixing sulfentrazone, Arquad 16/29 (hexadecyltrimethylammonium sulfate), and various comb-structured polymers in the amounts (in grams) and in the order listed in Table 26 below. Akzo PPEM 9376 is a comb polymer with ethoxylated side chains.

TABLE 26

| Formulation | 38-1 | 38-2 | 38-3 |
|---|---|---|---|
| Sulfentrazone | 7.5 | 7.5 | 7.5 |
| (5% solution) | | | |
| Ethacryl M | 0.72 | | |
| Ethacryl G | | 0.6 | |
| Akzo PPEM 9376 | | | 0.884 |
| NaOH | | 1.2 | 1.2 |
| (4% Solution) | | | |
| Arquad 16/29 | 3 | 3 | 3 |
| Total | 11.22 | 12.3 | 12.58 |

All three mixtures produced clear, pale yellow formulations. 0.50 grams of each aggregate was added to 20 mL of deionized water in a Nessler tube and mixed by inverting the tube. After 10 inversions all formed clear, transparent formulations which remained stable after 4 hours. A microscopic examination of the diluted solutions showed no visible aggregates, indicating that they possessed a particle size of less than one micron.

### Example 39

### Preparation of Aggregate of Oxamyl, Sokolan PA-15 and Arquad 18/50

0.105 grams of oxamyl technical, 0.456 grams of a 4% NaOH solution, 0.48 grams of Sokalan PA-15 (10% solution) and 0.65 grams of Arquad 18/50 were placed into a vial and stirred vigorously on a vibratory shaker, resulting in the production of a clear formulation. 0.03 grams of the formulation were mixed with 3 mL of deionized water, resulting in the formation of a white precipitate.

### Example 40

### Aggregates of Sokalan PA-15, Sulfentrazone, and Hexadecyltrimethylammonium Hydroxide

An aggregate of sulfentrazone is prepared using the acidic form of Sokalan PA-15, linear polyacrylic acid sodium salt with low molecular weight of 1200 g/mol, and hexadecyltrimethylammonium hydroxide. The sulfentrazone concentration in the mixtures is 0.5%; the Sokalan concentration is 0.2%; and the concentration of surfactant is 0.5%. An aggregate is obtained and is separated following the procedure described in Example 2.

1. A substantially water insoluble pesticidal aggregate produced from a mixture comprising:
(a) a polymer having at least three similarly charged electrostatic moieties;
(b) an amphiphilic surfactant having at least one electrostatically charged moiety of opposite charge to the polymer; and
(c) a pesticide.

2. The pesticidal aggregate of claim 1 wherein said aggregate is in the form of a precipitate.

3. The pesticidal aggregate of claim 1 wherein said aggregate is in the form of a colloidal dispersion.

4. The pesticidal aggregate of claim 1 wherein the pesticide comprises at least one electrostatically charged moiety.

5. The pesticidal aggregate of claim 4 wherein the charge in the pesticide is the same as that of the polymer.

6. The pesticidal aggregate of claim 1 wherein component (c) is a hydrophobic pesticide and component (a) is a hydrophilic polymer having at least three similarly charged electrostatic moieties.

7. The pesticidal aggregate of claim 1 wherein component (a) is a polycationic polymer and component (b) is an anionic surfactant.

8. The pesticidal aggregate of claim 1 wherein component (a) is a polyanionic polymer and component (b) is a cationic surfactant.

9. The pesticidal aggregate of claim 1 wherein pesticide component (c) is selected from the group consisting of hydroxybenzonitrites, pyridinecarboxylic acids, triazolopyrimidines, benzoic acids employed include phenoxycarboxylic acids, diphenyl ethers, glycine derivatives, benzoylureas, anilides, imidazoliniones, triketones, sulfonylureas, dinitroanilines, phenoxypropionates, quarternary ammonium compounds, gibberellins, pyrethroids, triazolinones, acetanilides, triazines, benzoic acids, azoles, strobilurins, substituted benzenes, triazoles, carbamates and dinitroanilies.

10. The pesticidal aggregate of claim 1 wherein pesticide component (c) is selected from the group consisting of 2,4-D, bromoxynil, clopyralid, cloransulam-methyl, dicamba, fenhexamid, fomesafen, glyphosate, glufosinate, imazethapyr, mesotrione, nicosulfuron, oryzalin, paraquat, diquat, quizalofop-P, sulfentrazone, lufenuron, novaluron, gibberellic acid, bifenthrin, sulfentrazone, metoachlor, atrazine, alachlor, acetochlor, dicamba, flutriafol, azoxystrobin, chlorothalonil, tebuconazole, oxamyl and pendimethalin.

11. The pesticidal aggregate of claim 1 wherein surfactant component (b) is on the United States Environmental Protection Agency's list of Inert (other) Pesticide Ingredients in Pesticide Products.

12. The pesticidal aggregate of claim 1 wherein surfactant component (b) is selected from the group consisting of alkyltrimethylammonium bromides, alkyltrimethylammonium chlorides, alkyltrimethylammonium hydroxide, ethoxylated quarternary ammonium salts, alkylsulfates, alkylbenzene sulfonates and phosphate esters of tristyrylphenol.

13. The pesticidal aggregate of claim 1 wherein surfactant component (b) is selected from the group consisting of tetradecyltrimethyl ammonium bromide, hexadecyltrimethyl ammonium bromide, dodecyltrimethyl ammonium chloride, hexadecyltrimethylammonium chloride, octadecyltrimethylammonium chloride, cocoalkyltrimethylammonium chloride, tallowalkyltrimethyl ammonium chloride, cocoalkylmethyl[ethoxylated(2)]-ammonium nitrate, cocoalkylmethyl[ethoxylated(2)]-ammonium chloride, cocoalkylmethyl[ethoxylated(15)]-ammonium chloride, tris(2-hydroxyethyl)tallowalkylammonium acetate, oleylmethyl[ethoxylated(2)]-ammonium chloride, hydrogenated tallowalkyl (2-ethylhexyl)dimethyl ammonium sulfate, dicocoalkyldimethyl ammonium chloride, sodium dodecylsulfate, sodium dodecyl benzene sulfonate, phosphate esters of tristyrylphenol and sodium lauryl sulfate.

14. The pesticidal aggregate of claim 1 wherein component (a) is on the United States Environmental Protection Agency's list of Inert (other) Pesticide Ingredients in Pesticide Products.

15. The pesticidal aggregate of claim 1 wherein polymer component (a) is selected from the group consisting of styrene-acrylic copolymers, pentaerytritol ether cross-linked acrylic acid polymers, aqueous acrylic emulsions, linear polyacrylic acid polymers, sulfonated kraft lignin polymers, maleic anhydride/olefin copolymers, polystyrene sulfonic acid polymers, polyallylalkyl ammonium polymers poly[N,N-Dimethyl-N2-propenyl-2-propen-1-ammonium chloride], poly(alkylene oxide)-block-poly(vinylpyridinium)copolymers, quaternized copolymers of vinylpyrrolidone and dimethylaminoethyl methacrylate, vinylpyrrolidone copolymers, methyl vinyl ether maleic anhydride ester copolymers and polyether polycarboxylates and their salts.

16. The pesticidal aggregate of claim 1 wherein polymer component (a) is selected from the group consisting of Metasperse 550S, Carbopol 71G, Carbopol Aqua 30, Polyquarternium 7, Sokalan PA 15, Sokalan PA 25 CLPN, Sokalan 30 CLPN, Sokalan PA 40, Sokalan PA 110s, REAX 88B, Geropon EGPM, poly(N,N-diallyl-N,N-dimethylammonium chloride), Polyquarternium 11, poly(ethylene oxide)-block-poly(N-ethyl-4-vinylpyridinium bromide), poly[N,N-Dimethyl-N-2-propenyl-2-propen-1-ammonium chloride], Akzo PPEM 9376, Ethacryl P, Ethacryl M, Ethacryl G and Ethacryl HF.

17. A pesticidal composition comprising the pesticidal aggregate of claim 1 and an agriculturally acceptable carrier.

18. The pesticidal composition of claim 17 wherein the pesticide comprises at least one electrostatically charged moiety.

19. The pesticidal composition of claim 18 wherein the charge in the pesticide is the same as that of the polymer.

20. The pesticidal composition of claim 17 wherein component (c) is a hydrophobic pesticide and component (a) is a hydrophilic polymer having at least three similarly charged electrostatic moieties.

21. The pesticidal composition of claim 17 wherein component (a) is a polycationic polymer and component (b) is an anionic surfactant.

22. The pesticidal composition of claim 17 wherein component (a) is a polyanionic polymer and component (b) is a cationic surfactant.

23. A method of controlling pests comprising applying to the locus of such pests a pesticidally effective amount of the pesticidal composition of claim 17.

24. The method of claim 23 wherein the pesticide comprises at least one electrostatically charged moiety.

25. The method of claim 24 wherein the charge in the pesticide is the same as that of the polymer.

26. The method of claim 23 wherein component (c) is a hydrophobic pesticide and component (a) is a hydrophilic polymer having at least three similarly charged electrostatic moieties.

27. The method of claim 23 wherein component (a) is a polycationic polymer and component (b) is an anionic surfactant.

28. The method of claim 23 wherein component (a) is a polyanionic polymer and component (b) is a cationic surfactant.
